(19) United States
(12) Patent Application Publication
(10) Pub. No.: US 2026/0081676 A1
(43) Pub. Date: Mar. 19, 2026

(54) ELECTRONIC DEVICE AND METHOD IN A NON-TERRESTRIAL WIRELESS COMMUNICATION SYSTEM

(71) Applicant: Sony Group Corporation, Tokyo (JP)

(72) Inventors: Mingtuo ZHOU, Shanghai (CN); Xiaoxue WANG, Beijing (CN); Haojin LI, Beijing (CN)

(73) Assignee: Sony Group Corporation, Tokyo (JP)

(21) Appl. No.: 19/135,379

(22) PCT Filed: Dec. 19, 2023
(86) PCT No.: PCT/CN2023/139696

§ 371 Date: Jun. 4, 2025

(30) Foreign Application Priority Data
Dec. 19, 2022 (CN) 202211631231.3

(51) Int. Cl. H04B 7/185; H04W 72/044

(52) U.S. Cl. CPC H04B 7/18513; H04W 72/046

(57) ABSTRACT

The present disclosure relates to an electronic device and method in a wireless communication system. Proposed is a beam relay/reflection device in a non-terrestrial wireless communication network. The beam relay/reflection device comprises a processing circuit, which is configured to receive a beam transmitted from a beam source in the non-terrestrial wireless communication network and, on the basis of configuration information of a target object, transmit the received beam to the target object, the beam source being an aerial device that is in the non-terrestrial wireless communication network and is capable of transmitting beams.

### CROSS-REFERENCE OF RELATED APPLICATIONS

The present application claims the priority of Chinese patent application No. 202211631231.3 filed on Dec. 19, 2022, which is incorporated by reference herein in its entity.

### FIELD OF THE INVENTION

The present disclosure relates to wireless communication, and in particular, to wireless communication in a non-terrestrial network.

### BACKGROUND

With development and widespread application of mobile Internet technology, more and more devices are connected into mobile networks, and new services and applications are emerging in endlessly. In order to meet people's communication requirements, a fifth-generation mobile communication technology (referred to as 5G or 5G technology) has become a hot spot of discussion and research in the communication industry and academia. In the 5G era where mobile communication has been developed rapidly, terrestrial mobile communication system and non-terrestrial mobile communication network have been proposed, the terrestrial mobile telecommunication system can meet most of users'requirements, but it may not meet the requirements in the ocean, sparsely populated land and other scenarios, while the existence of the Non-terrestrial network (NTN) can complement the application scenario requirements in the terrestrial mobile communication system.

Therefore, an improved mechanism is needed to deal with the new challenges in 5G communication, especially that in non-terrestrial networks.

Unless otherwise stated, it should not be assumed that any of the methods described in this section become prior art only because they are included in this section. Similarly, unless otherwise stated, the problems recognized about one or more methods should not be assumed to be recognized in any prior art on the basis of this section.

### DISCLOSURE OF THE INVENTION

The present disclosure provides an optimization scheme for configuration of a wireless communication system, especially a wireless communication system based on a non-terrestrial network.

An aspect of the present disclosure relates to a beam relay/reflection device in a non-terrestrial wireless communication network, the beam relay/reflection device may include a processing circuit which may be configured to receive a beam emitted from a beam source in the non-terrestrial wireless communication network, and transmit the received beam to a target object based on setting information of the target object, the beam source is an aerial device capable of emitting beams in the non-terrestrial wireless communication network.

Another aspect of the present disclosure relates to a control-side device in a non-terrestrial wireless communication network, the control-side device may include a processing circuit which may be configured to acquire setting information of a target object of beam transmission in the non-terrestrial wireless communication network, determine a beam relay/reflection device that can be used to receive and transmit a beam from a beam source based on the setting information of the target object, wherein the beam source is an aerial device capable of emitting beams in the non-terrestrial wireless communication network, and send the setting information of the target object to the determined beam relay/reflection device, so that the beam relay/reflection device can transmit the received beam from the beam source to the target object.

Yet another aspect of the present disclosure relates to a beam relay method for a wireless communication system, which may include receiving a beam emitted from a beam source in the non-terrestrial wireless communication network, and transmitting the received beam to a target object based on setting information of the target object, the beam source is an aerial device capable of emitting beams in the non-terrestrial wireless communication network

Yet another aspect of the present disclosure relates to a method for a control-side device in a wireless communication system, the method may include: acquiring setting information of a target object of beam transmission in the non-terrestrial wireless communication network, determining a beam relay/reflection device that can be used to receive and transmit a beam from a beam source based on the setting information of the target object, wherein the beam source is an aerial device capable of emitting beams in the non-terrestrial wireless communication network, and sending the setting information of the target object to the determined beam relay/reflection device, so that the beam relay/reflection device can transmit the received beam from the beam source to the target object.

Yet another aspect of the present disclosure relates to a wireless communication device. According to an embodiment, the wireless communication device may include a processor and a storage device having stored program codes and/or executable instructions thereon, and the program codes and/or executable instructions, when executed by the processor, cause the processor to implement the method according to any embodiment of the present disclosure.

Yet another aspect of the present disclosure relates to a wireless communication apparatus including means for implementing the method according to any embodiment of the present disclosure.

Yet another aspect of the present disclosure relates to a non-transitory computer-readable storage medium storing program codes and/or executable instructions thereon, and the program codes and/or executable instructions, when executed by a processor, cause the processor to implement the method according to any embodiment of the present disclosure.

Yet another aspect of the present disclosure relates to a computer program product comprising program codes and/or instructions, which is executable by an electronic device to implement the method the method according to any embodiment of the present disclosure.

Yet another aspect of the present disclosure relates to a computer program comprising instructions which, when executed by a computer, cause the computer to implement the method according to any embodiment of the present disclosure.

The above summary is provided in order to summarize some exemplary embodiments and provide a basic understanding of various aspects of the subject matter described herein. Accordingly, the above features are exemplary only and should not be construed as in any way narrowing the scope or spirit of the subject matter described herein. Other features, aspects, and advantages of the subject matter described herein will become apparent from the following detailed description, taken in conjunction with the accompanying drawings.

### DESCRIPTION OF THE DRAWINGS

Hereinafter, the above and other objects and advantages of the present disclosure will be further described in combination with specific embodiments with reference to the accompanying drawings. In the drawings, the same or corresponding technical features or components will be denoted by the same or corresponding reference numerals.

FIG. 1 shows an example of the coverage of satellite beams on earth.

FIG. 2 shows a conceptual diagram of enhancing communication performance by using a beam relay/reflection device in a wireless communication system based on a non-terrestrial network (NTN) according to an embodiment of the present disclosure.

FIG. 3A shows a block diagram of a beam relay/reflection device in a wireless communication system based on a non-terrestrial network according to an embodiment of the present disclosure.

FIG. 3B shows a flowchart of a beam relay method in a wireless communication system based on a non-terrestrial network according to an embodiment of the present disclosure.

FIG. 4 shows a schematic diagram of reflecting beams by using intelligent reflection surfaces (IRS) to cover a target area and/or a terminal in an NTN network according to an embodiment of the present disclosure.

FIG. 5 shows a schematic diagram of reflecting beams by using intelligent reflection surfaces to strengthen signals received by a terminal in a case of GEO satellite communication, according to an embodiment of the present disclosure.

FIGS. 6A and 6B show schematic diagrams of reflecting beams by using multiple intelligent reflection surfaces to strengthen signals received by a terminal in an NTN network according to an embodiment of the present disclosure.

FIG. 7 shows a schematic diagram of reflecting beams by using intelligent reflection surfaces to cover a boundary area among multiple cells and an occluded area in an NTN network according to an embodiment of the present disclosure.

FIG. 8 shows a schematic diagram of reflecting beams by using intelligent reflection surfaces to cover a designated small area in an NTN network according to an embodiment of the present disclosure.

FIG. 9 shows a schematic diagram of a designated area being divided into small areas adapted to be covered by beams reflected by intelligent reflection surface according to an embodiment of the present disclosure.

FIG. 10 shows a flow chart of reflecting beams by intelligent reflection surfaces to cover a fixed target area according to an embodiment of the present disclosure.

FIG. 11A shows a schematic diagram of satellite handover when intelligent reflection surfaces are used to reflect beams to cover a fixed area in an NTN network using non-transparent satellites according to an embodiment of the present disclosure.

FIG. 11B shows a flowchart of reflecting beams by using intelligent reflection surfaces to cover a fixed area when satellites are handed over in an NTN network using non-transparent satellites according to an embodiment of the present disclosure.

FIG. 12A shows a schematic diagram of satellite handover when intelligent reflection surfaces are used to reflect beams to cover a fixed area in an NTN network using transparent satellites according to an embodiment of the present disclosure.

FIG. 12B shows a flowchart of reflecting beams by using intelligent reflection surfaces to cover a fixed area when satellites are handed over in an NTN network using transparent satellites according to an embodiment of the present disclosure.

FIG. 13 shows a schematic diagram of dividing time slots and dividing small areas in a time interval when intelligent reflection surfaces are used to reflect beams to cover a mobile area in an NTN network according to an embodiment of the present disclosure.

FIG. 14 shows a flowchart of using intelligent reflection surfaces to reflect beams to cover a mobile target area in an NTN network according to an embodiment of the present disclosure.

FIG. 15 shows a flowchart of using intelligent reflection surfaces to reflect beams to cover a mobile target area in an NTN network according to an embodiment of the present disclosure.

FIG. 16 shows a schematic diagram of using intelligent reflection surfaces to reflect beams to strengthen signals received by a terminal in an NTN network according to an embodiment of the present disclosure.

FIG. 17 shows a flowchart of using intelligent reflection surfaces to reflect beams to strengthen signals received by a terminal in an NTN network according to an embodiment of the present disclosure.

FIG. 18 shows a schematic diagram of acquiring beam directions of the terminal through beam measurement when intelligent reflection surfaces are used to reflect beams to strengthen signals received by a mobile terminal in an NTN network according to an embodiment of the present disclosure.

FIG. 19 shows a flowchart of using intelligent reflection surfaces to reflect beams to strengthen signals received by a mobile terminal in an NTN network according to an embodiment of the present disclosure.

FIG. 20 shows a flowchart of system registration and registration information updating of intelligent reflection surfaces in an NTN network according to an embodiment of the present disclosure.

FIG. 21A shows a block diagram of a control-side electronic device in a wireless communication system based on a non-terrestrial network according to an embodiment of the present disclosure.

FIG. 21B shows a flowchart of a method for a control side in a wireless communication system based on a non-terrestrial network according to an embodiment of the present disclosure.

FIG. 22 schematically illustrates a block diagram of an exemplary structure of a personal computer as an information processing device that can be employed in an embodiment of the present disclosure.

FIG. 23 is a block diagram illustrating a first example of a schematic configuration of an eNB to which the technology of the present disclosure can be applied.

FIG. 24 is a block diagram illustrating a second example of a schematic configuration of an eNB to which the technology of the present disclosure can be applied.

FIG. 25 is a block diagram illustrating an example of a schematic configuration of a smart phone to which the technology of the present disclosure can be applied; and

FIG. 26 is a block diagram illustrating an example of a schematic configuration of a vehicle navigation device to which the technology of the present disclosure can be applied.

Although embodiments of the present disclosure may be susceptible to various modifications and alternative forms, the embodiments of the present disclosure are shown by way of example in the drawings and are described in detail herein. It should be understood that the drawings and detailed description thereof are not intended to limit the embodiments to the particular forms disclosed, on the contrary, the intention is to cover all modifications, equivalents, and alternatives falling within the spirit and scope of the claims.

### DETAILED DESCRIPTION OF PREFERRED EMBODIMENTS

Hereinafter, exemplary embodiments of the present disclosure will be described with reference to the accompanying drawings. For the sake of clarity and conciseness, not all features of the embodiments are described in the description. However, it should be understood that many implementation-specific settings must be made during the implementation of the embodiments in order to achieve specific goals of developers, for example, to meet those constraints related to equipment and business, and these constraints may vary with different implementations. In addition, it should be understood that although the development work may be very complicated and time-consuming, it is only a routine task for those skilled in the art who benefit from the present disclosure.

Here, it should also be noted that in order to avoid obscuring the present disclosure by unnecessary details, only processing steps and/or device structures closely related to the schemes at least according to the present disclosure are shown in the drawings, while other details not closely related to the present disclosure are omitted. It should be noted that similar reference numerals and letters indicate similar items in the drawings, and therefore, once an item is defined in one drawing, there is no need to discuss it for subsequent drawings.

In the present disclosure, the terms “first”, “second” and the like are only used to distinguish elements or steps, and are not intended to indicate time sequence, preference, or importance.

At present, 5G communication can be used in various applications, and its performance targets include at least one of high data rate, delay reduction, energy saving, cost reduction, system capacity improvement and large-scale equipment connection. With the rapid development of the number of networked users and communication requirements, various types of mobile data transmission will bring severe challenges to the network, especially accompanied by complicated data transmission operations and increased power consumption. This puts forward higher demands for current wireless communication, especially for normal operation time and coverage of the network, so it is necessary to develop and adopt new technologies.

In particular, the recent cellular network technology has been mainly developed based on a terrestrial network infrastructure, which can meet most of users'requirements, but it is often difficult to meet the requirements in the ocean, sparsely populated land and other scenarios, therefore, a Non-terrestrial network (NTN) is proposed, and particularly, air links and even space links, such as satellite links, which could implement communication without depending on a terrestrial infrastructure, were introduced into the 5G network, effectively supplementing the performance of the terrestrial 5G network. On one hand, the non-terrestrial network can complement communication without depending on a terrestrial infrastructure, so in a sense, the non-terrestrial network can expand the existing terrestrial networks or “fill in” their loopholes. For example, a mobile network operator (MNO) can use a non-terrestrial network, such as satellite communication, to provide 5G services to areas lacking infrastructures. Non-terrestrial networks also support mobile network operators to provide services normally when terrestrial networks are interrupted (such as natural disasters). Non-terrestrial networks can also extend 5G services to a wider range of mobile platforms. For example, non-terrestrial networks can provide services for airplanes, ships and trains in remote areas where terrestrial network infrastructures cannot be built. 5G NTN can also enhance the service continuity of machine-to-machine (M2M) and Internet of Things (IoT) devices, and improve the reliability of mission-critical communication. For example, M2M and IoT applications located on the edge of coverage or in hard-to-reach locations can access 5G through non-terrestrial networks. 5G NTN can also provide stable 5G coverage for passengers on mobile platforms such as airplanes and trains.

In various NTN scenarios, various types of satellites, high-altitude platforms, etc. can be used to realize communication links independent of terrestrial infrastructures and realize beam emission to cover terrestrial areas. In particular, various types of satellites include GEO satellites, LEO satellites and so on.

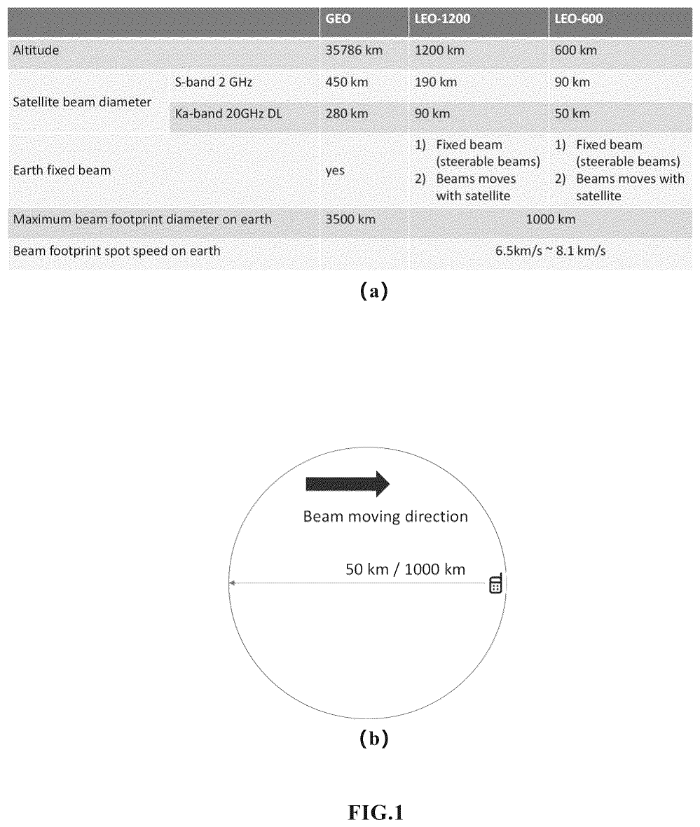

FIG. 1 schematically shows an example of coverage of satellite beams on earth, in which (a) shows typical projection sizes of satellite beams on earth. As shown in FIG. 1(a), for a GEO satellite and LEO satellites with altitudes of 1200 km and 600 km respectively, the projection diameters of beams on earth are 450 km, 190 km and 90 km respectively when the operation frequency band is 2GHz, and 280 km, 90 km and 50 km respectively when the operation frequency band is 20GHz, the maximum beam projection diameters of GEO satellite and LEO satellite on earth can be 3500 km and 1000 km respectively. The projection of the GEO satellite beam on earth is stationary relative to earth, which can be considered as a fixed beam on earth. For the LEO satellite, there are two designs for the projection of beams on earth, one of which is designed to be that the beams move on earth with the movement of LEO satellite, in the above example, the speed of LEO beam movement relative to earth is between 6.5 km/s and 8.1 km/s. FIG. 1(b) shows a typical duration of a beam covering a terminal. As shown in FIG. 1(b), in the case of moving beam projection, when the beam movement speed is 8km/s and the LEO satellite beam moves from 50 km to 1000 km, the maximum coverage time of the LEO satellite communication terminal is between 6.25 seconds (50km/(8km/s)) and 125 seconds (1000km/(8km/s)).

Another design is beam projection using steering antennas. For example, the steering antenna technology can be used to make a beam projection on earth in a certain range, such as in a certain time or space range, which can be called a fixed beam and a steerable beam. The steering antenna technology can make the beam projection on earth relatively fixed, but it is relatively difficult to meet the coverage requirements for all terminals when there are multiple terminals. Secondly, the steering antenna technology is relatively complicated, and when LEO/MEO satellite moves to a relatively far position, the satellite downlink signal that the terminal can receive will become relatively weak, and the terminal also needs to boost its transmission power so that the satellite can receive an uplink signal with sufficient strength.

It should be pointed out that in a non-terrestrial network, there may be some problems due to a NTN base station being far away from the ground or a satellite/high-altitude platform moving: (1) There exist loopholes in beam coverage or areas with weak coverage, such as areas that are blocked by mountains or buildings, projection boundary areas between multiple NTN base stations beams on earth, etc., such areas may be fixed or mobile; (2) The signals received by the terminal are relatively weak; (3) The coverage duration of the beam for the cell is short, and the terminal need to switch frequently. Generally speaking, in the current technology, multiple satellites can be used to repeatedly cover areas with loopholes or weak coverage from different directions; for the problem of weak signal received by the terminal, more antennas and better signal amplifiers can be used. However, the usage of multi-satellites often leads to a complex system, and the usage of multi-antennas and multi-signal amplifiers in the terminal will increase the difficulty of designing the terminal device, and may not be able to achieve cost-effective performance improvement.

In view of this, the present disclosure proposes to use a signal relay/reflection device to improve the signal reception and area coverage of the non-terrestrial network. In particular, by properly arranging and operating a signal relay/reflection device in the non-terrestrial network, beams from high-altitude or even space communication links can be received and transmitted to a receiving side in the system, such as a communication area, a communication terminal, etc., so that the coverage for the area can be enhanced, and/or the signals received by the terminal can be strengthened, and/or the cell coverage duration can be extended.

In particular, a signal relay/reflection device can also be called a beam relay/reflection device, which can receive beams from a beam source and transmit the beams to a target object. The signal relay/reflection device can be any of various suitable types of devices. In some embodiments, the signal relay/reflection device can be realized in a passive mode, for example, in a reflective way, which can reflect the beams from the beam source to the reflective-type device on the receiving side, and can be realized by using an intelligent reflection surface technology as an example. Intelligent reflection surface (IRS) is usually a plane composed of a large number of micro controllable reflection units, and each reflection unit can be independently controlled to change amplitudes and phases of reflected beams/electromagnetic waves, so that the intelligent reflection surface can control propagation of the beams through the whole channel, and desired effects can be achieved at the receiving side, such as enhancing the area coverage, strengthening the received signals, and eliminating interference, or the like. Therefore, in an exemplary embodiment of the present disclosure, the beams emitted by a beam source in the NTN can be appropriately reflected by the intelligent reflection surface to cover a target area and/or a target terminal, so as to achieve at least one of improving the coverage loophole, strengthening signals received by the terminal, extending the beam coverage duration, and reducing the terminal switching, or the like.

As an example, the present disclosure proposes to utilize an intelligent reflection surface to reflect NTN signals in the non-terrestrial network, including: (1) strengthening downlink signals from a NTN base station such as a satellite or a high-altitude platform and uplink signals from a terminal when the satellite or high-altitude platform of the NTN network are far away from the terminal, such as when a LEO satellite is farther and farther away from the terminal; (2) by means of the reflection by the intelligent reflection surface, extending the coverage duration of the NTN base station signal beam projection to the terminal, when the satellite or the high-altitude platform is far away from the terminal in the NTN network; (3) in the non-terrestrial network, there may be coverage blind areas, such as areas blocked by mountains and buildings, the NTN satellite/high-altitude platform base station signals can be reflected by the intelligent reflection surface technology to cover such areas.

In the present disclosure, as an example, in a non-terrestrial network communication system, a signal relay/reflection device, especially an intelligent reflection surface, can be installed in an appropriate location, such as a fixed position, for example, a high mountain top, a building top, etc., or a relatively fixed location, such as High-Altitude Platform Station (HAPS); or a mobile location, such as a drone, an airplane, or a LEO/MEO satellite, such as GEO and MEO satellites, etc., which can be used for serving not only a ground terminal, but also for a terminal located in the air (including space). In particular, the high-altitude platform station can be arranged at a desired position as required. Moreover, the high-altitude platform station can be stationary relative to the earth for a long time, and the geographical location including height can be adjusted as needed, so the installation of the intelligent reflection surface can have high flexibility. In addition, there are about 100,000 planes flying in the air all over the world concurrently, which can also be used as ideal intelligent reflection surface carriers.

A conceptual overall operation of enhancing communication performance by using beam relay/reflection device in a wireless communication system based on a non-terrestrial network according to an embodiment of the present disclosure will be described below with reference to the accompanying drawings. As an example, a non-terrestrial wireless communication system or radio system at least includes a beam source, a beam relay/reflection device, a target object, a control-side device, and the like. In operation, the beams from the beam source can be received and transmitted to the target object by the control-side device via the beam relay/reflection device to achieve beam coverage for the target object. Additionally, the control of the beam source and the beam relay/reflection device and/or the information interaction between the beam source and the beam relay/reflection device can also be realized via the control-side device, thereby further optimizing the beam processing.

According to an embodiment of the present disclosure, the control-side device, the beam source, the beam relay/reflection device, the target object or the like in the wireless communication system can be realized in various appropriate ways.

In some embodiments, the control-side device may refer to a device on a control side in a wireless communication system. “Control side” has the full breadth of its usual meaning, and correspondingly, it can include a side that performs corresponding control/processing on communication operations for various devices in a system. As an example, various devices in the system may include a beam transmission device or a beam source, a beam relay/reflection device, a terminal device or the like in a wireless communication system. In the present disclosure, the control-side device can acquire setting information of various devices to control the operations of the devices, such as setting/adjusting the setting parameters for communication. As an example, the control-side device can realize information interaction between at least two of the beam source, the beam relay/reflection device and the target object, for example, interaction of their respective setting information, thus contributing to the operation of each device.

In the present disclosure, the control-side device may include any suitable device in the network. In some embodiments, the control-side device may include, for example, a base station, a control device, a server or MEC, a repeater, or the like in a wireless communication system such as a cellular communication system, V2X system, or the like. In the present disclosure, the term “base station” has the full breadth of its usual meaning, and as an example, a base station can be, for example, an eNB complying with the 4G communication standard, a gNB complying with the 5G communication standard, a remote radio head end, a wireless access point, an aircraft control tower, or a communication device performing similar functions. In particular, the control-side device can be set in the system in an appropriate way, for example, integrated with the beam source or set separately from the beam source.

In the present disclosure, a beam source refers to a component that emits beams for communication, usually a component in a non-terrestrial network that emits beams far from the ground, as an example, it can be a device that is located at high altitude or even in space and is suitable for emitting communication beams to cover a ground area to realize communication, such as a satellite, an aircraft, a high-altitude aircraft, a high-altitude platform, and the like. A beam source can be controlled by a control-side device in a communication system such as a base station to provide communication beams to a ground cell. In some embodiments, the beam source can be integrated with the base station, for example, it can be called a satellite base station, as an example, in a non-terrestrial network, for example, a satellite can emit beams and also serve as a base station in the non-terrestrial network. In other embodiments, the beam source can be separated from the base station, for example, the satellite can be used to emit beams, while the base station in the non-terrestrial network can be any other component in the network, for example, the base station can be located on the ground or at any other appropriate location in the network, and the beam emission of the beam source can be controlled through wireless communication between the base station and the beam source. The satellite can transmit its setting information to the base station, so that the base station can send the setting information to the intelligent reflection surface and/or the terminal device in the target area.

In some embodiments, a target object, which may also be called a beam coverage target object, may refer to an object to which beams emitted by a beam source can be applied, especially an object to which the beams can be transmitted through beam relaying. A target object generally refers to any of various appropriate objects in a wireless network that receive beams for communication, such as a cell intended to be covered by relayed beams (which may be called a target cell), a terminal in a cell (which may be called a target terminal), or the like. For example, the target cell may refer to a terrestrial communication cell in a wireless communication system, which may include several terminal-side devices. In the present disclosure, it should be pointed out that in addition to being covered by the relayed beams, the target object can also receive direct beams from the beam source, or the reflected beams from other means, and so on.

In the present disclosure, the term “terminal device” has the full breadth of its usual meaning, and at least includes a terminal device as a part of a wireless communication system or a radio system that receives a signal from a transmission-side device to facilitate communication. As an example, the terminal device may be a device, such as, a wireless relay, a micro base station, a router, user equipment, or the like, or a communication apparatus that performs similar functions. In the present disclosure, “terminal device” and “user equipment (UE)” can be used interchangeably, or “terminal device” can be incorporated with or realized as a part of “user equipment”. In the present disclosure, the term “user equipment (UE)” has the full breadth of its usual meaning, and as an example, the user equipment may be a terminal device such as a mobile phone, a laptop computer, a tablet computer, a vehicle-mounted communication device, or a communication apparatus that performs similar functions.

In some embodiments, the beam relay/reflection device can realize signal reception and transmission through various appropriate ways. In one example, it can be achieved by reflection. In this case, the beam relay/reflection device can be called a beam reflection device, which can receive a beam from the beam source and reflect it toward the target cell. As an example, the beam reflection device can be an intelligent reflection surface, and it should be pointed out that in the context of the present disclosure, the intelligent reflection surface is only a schematic example of a beam relay/reflection device, and is not restrictive. In another example, additionally or alternatively, after receiving the beam, the beam relay/reflection device may perform appropriate processing thereon, which may include beam augmentation (e.g., power augmentation), etc., and then send the processed beam to the target object. In this case, the beam relay/reflection device may be implemented in an active mode, and it may be called a beam relay device, which will not be described in detail here. In the context of the present disclosure, beam reception and transmission can also be carried out in other ways, as long as such devices can receive incident beams, control or process beam emission to achieve target area coverage, signal augmentation, and the like. As an example, the above active and passive modes can be combined with each other, and the beam relay/reflection device can be a device that realizes at least one of beam relay and beam reflection. In addition, the device can also include various other appropriate and necessary signal processing, such as filtering, noise reduction and so on.

In some embodiments, in particular, the beam relay/reflection device can be fixedly arranged, for example, at a fixed location, such as the top of a mountain or a building, or can be movably arranged, for example, on a relatively fixed or movable equipment, as mentioned above. In the context of the present disclosure, a beam relay/reflection device can realize appropriate beam relaying based on at least one of its own setting information, setting information of a target object, setting information of a beam source, and the like, which will be described in detail below.

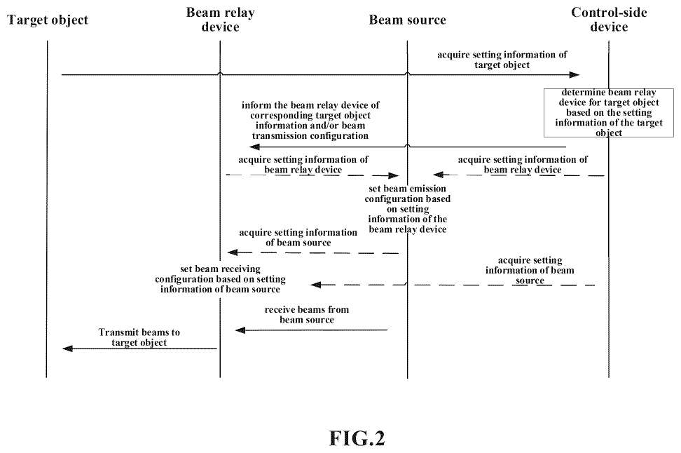

A schematic signaling diagram of beam transmission to a target object by using a beam relay/reflection device in a wireless communication system based on a non-terrestrial network according to an embodiment of the present disclosure will be briefly described below with reference to FIG. 2.

First, for a target object to be beam-transmitted, at least one beam relay/reflection device corresponding to the target object can be determined. Such determination may be performed by any appropriate device in the network, for example, by a control-side device. As an example, the control-side device can acquire the setting information of the target object, including but not limited to location information, and so on, to select a beam relay/reflection device suitable for transmitting beams to the target object.

Then, the selected at least one beam relay/reflection device receives the beams from the beam source and then transmits the beams to the target object. In particular, the control-side device can send the setting information of the target object, beam transmission setting information and the like to the beam relay/reflection device, so that the beam relay/reflection device can transmit the beams to a corresponding target object according to the setting information of the target object and the beam transmission setting information. In particular, the setting information of the target object may include, but not limited to, location information of the target object, including the location, shape, information of segmented sub areas, etc., the beam transmission setting information may include, but not limited to, beam transmission time information, including, but not limited to, beam transmission start time, beam transmission end time, etc. It may also include setting information of the beam source as the beam provider. As an example, the beam relay/reflection device may transmit a beam to the target object between the beam transmission start time and the beam transmission end time, based on the location information of the target object.

In some embodiments, in particular, the beam relay/reflection device can set its beam relay configuration based on the setting information of the target object, especially, for example, its location information, so that the beam is more appropriately relayed to the target object. For example, if the beam relay/reflection device is a reflection surface, its beam relay configuration may include a reflection configuration, including a reflection angle, etc., so as to properly reflect the beam received from the beam source to the target object and realize the coverage for the target object.

According to an embodiment of the present disclosure, the beam from the beam source may be a direct beam emitted from the beam source, or a beam that has undergone several reflections or scatterings in the environment. According to an embodiment of the present disclosure, the beam relay/reflection device can also set its beam relay configuration, especially the beam reception configuration, based on the setting information of the beam source, so that the beam reception and transmission are more matched, and the beam relay/reflection device can receive the beam from the beam source more accurately and appropriately. In particular, in some embodiments, the setting information of the beam source can be informed by the control-side device to the beam relay/reflection device. For example, the control-side device can inform the beam relay/reflection device of the setting information of the beam source, such as the spatial location information of the satellite and the azimuth information of the transmitted beam, such as the spatial angle, and the ephemeris of the satellite, so that the beam relay/reflection device can adjust its beam receiving configuration, such as the beam receiving direction and the beam receiving angle, based on the setting information of the beam source, so as to match the beam transmitted by the beam source, track the beam source and receive the transmitted beam more accurately.

It should be pointed out that when the beam source is a high-speed mobile satellite, the high-speed mobile satellite will cause the beam direction of the transmitted beam to change rapidly, which may make it difficult for the beam relay/reflection device to receive the transmitted beam. In this case, the beam source is tracked by the beam relay/reflection device, so that the beam relay/reflection device can accurately receive the transmitted beam from the beam source even if the direction of the transmitted beam changes rapidly.

As another example, the beam relay/reflection device can also set its beam relay configuration based on the setting information of both the beam source and the target object (target area and/or terminal device), for example, the beam reception for the beam source can be improved based on the setting information of the beam source, and the beam transmission for the target object can be optimized based on the configuration of the target object. It should be pointed out that when the beam relay/reflection device is set on a fast-moving device, such as a fast-moving aircraft, an airplane, etc., such fast-moving may often lead to difficulties in accurately receiving the beam from the beam source and transmitting the beam to the target object. In this case, the beam source and the target object both are tracked by the beam relay/reflection device, so that the beam relay/reflection device can accurately receive the transmitted beam from the beam source and accurately transmit the beam to the target object even if the direction of the transmitted beam changes rapidly.

According to an embodiment of the present disclosure, the beam emission of the beam source can also be set based on the setting information of the beam relay/reflection device, so that the beam from the beam source can be transmitted to the beam relay/reflection device more accurately. The setting information of the beam relay/reflection device can be informed to the beam source in various appropriate ways, for example, the beam source is informed by the control-side device. In particular, the control-side device can inform the beam source of the setting information of the beam relay/reflection device, including the location information of the beam relay/reflection device and the beam receiving configuration, so that the beam source can adjust the beam emission direction based on the setting information of the beam relay/reflection device, so that the beam can be emitted toward the beam relay/reflection device more accurately.

According to an embodiment of the present disclosure, the interaction between the setting information of the beam source and the setting information of the beam relay/reflection device can be performed in various appropriate ways. For example, it can be done via the control-side device, as described above. For example, according to the situation of wireless network, information interaction can also be directly carried out between the beam source and the beam relay/reflection device, for example, without any intermediate device, such as without going through the control-side device. Alternatively, it can be done via other devices in the wireless network. Through information interaction, the beam source and beam relay/reflection device can be more matched, and the beam transceiving is more appropriate and accurate.

According to embodiments of the present disclosure, information interaction between a beam source and a beam relay/reflection device can be performed in an appropriate manner. In some embodiments, the interaction may occur periodically, such as at specific intervals. Such an interval can be appropriately set in various ways. As an example, it can be set according to the motion condition of the beam relay/reflection device, for example, when the beam relay/reflection device is basically stationary, the configuration of the beam relay/reflection device can be informed to the control-side device and/or the beam source at a long interval; Or in a case that the beam relay device moves fast, the configuration of the beam relay/reflection device can be informed to the control-side device and/or the beam source at a short interval. As another example, it can also be set according to the motion condition of the beam source (such as satellite or NTN base station). In other embodiments, the interaction can be performed on demand, for example, the interaction can be performed at the request of any one of the control-side device, the beam source or the beam relay/reflection device. Therefore, during the operation, the beam source and the beam relay/reflection device can always be properly aligned or matched, and the beam from the beam source can be received more appropriately.

The implementation of a wireless communication system based on a non-terrestrial network according to an embodiment of the present disclosure will be described in further detail below.

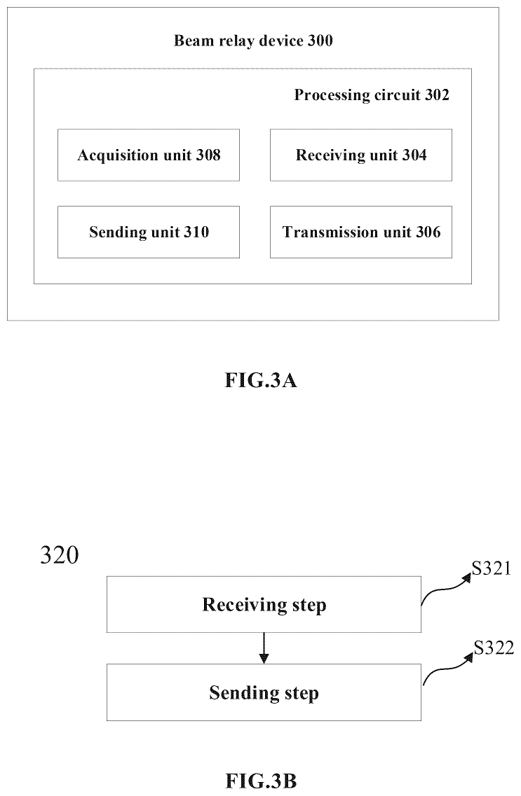

FIG. 3A shows a block diagram of a beam relay/reflection device in a wireless communication system based on a non-terrestrial network according to an embodiment of the present disclosure. In particular, the beam relay/reflection device can cooperate with a beam source in the wireless communication system to enhance beam transmission to a target object.

The beam relay/reflection device 300 includes a processing circuit 302 configured to receive a beam emitted from a beam source in the non-terrestrial wireless communication network, and transmit the received beam to a target object based on setting information of the target object, the beam source is an aerial device capable of emitting beams in the non-terrestrial wireless communication network.

According to an embodiment of the present disclosure, for a target object, a beam relay/reflection device for beam transmission to the target object can be determined appropriately. In particular, in some embodiments, it can be set by the control-side device in the non-terrestrial wireless communication network based on the setting information of the target object. It should be noted that the beam relay/reflection device for beam transmission to the target object may include at least one beam relay/reflection device.

In some embodiments, the setting information of a target object may include location, size, shape, etc. of the target object. As an example, a target object may generally refer to a cell in a wireless network that is intended to be covered by a relayed beam, which may be called a target cell, and in this case, the setting information of the target object may include at least one of the location of the target cell, the size of the target cell, the operating frequency of the target cell, and the like. As another example, additionally or alternatively, a target object may generally refer to a terminal in a cell in a wireless network for which signal strengthening is intended to be performed by means of a relayed beam, which may be referred to as a target terminal, and in this case, the setting information of the target object may include at least one of the location of the terminal device, the operating frequency of the terminal device, and the like. Therefore, at least one beam relay/reflection device adapted to beam coverage for the target cell or the target terminal can be selected based on the setting information of the target cell or the target terminal.

In some embodiments, the control-side device can set at least one beam relay/reflection device for beam transmission to the target object further based on the setting information of the beam relay/reflection device. According to an embodiment of the present disclosure, the setting information of the beam relay/reflection device may include at least one of azimuth information, transmission setting information, etc. of the beam relay/reflection device. In particular, in some embodiments, the azimuth information of the beam relay/reflection device may include at least one of altitude, orientation, geo-location, etc. of the beam relay/reflection device. In particular, a beam relay/reflection device adapted to the target cell or the target terminal device can be selected based on at least one of the orientation and transmission configuration of the beam relay/reflection device. In this case, it can be considered that at least one beam relay/reflection device can be set based on setting information of both the target object and the beam relay/reflection device.

As an example, when the beam relay/reflection device is an intelligent reflection surface, one or more appropriate intelligent reflection surfaces can be selected based on at least one of location, reflection angle, coverage, etc. of the intelligent reflection surface, the mutual positional relationship, orientation relationship between the intelligent reflection surface and a target cell or a target terminal device, configuration and requirements of the target cell or the target terminal itself, etc.

As an example, when the coverage of an intelligent reflection surface is sufficient, one intelligent reflection surface can be used to cover the target area. As another example, when the target area is relatively large, multiple intelligent reflection surfaces can be used to cover the target area. For example, respective coverages of the multiple intelligent reflection surfaces can be spliced to achieve coverage for a larger target area, thus providing more adequate signal coverage for the target area. As yet another example, when a target cell or terminal device is located at a position where the beam coverage by the beam source is weak, such as at a blocked position, at the cell boundary, etc., a plurality of reflection surfaces can be arranged to reflect a plurality of beams, so that the number of coverage beams for the target area or the target terminal can be increased, and thus the beam signal strength can be increased. This is especially true when the signal strength reflected by a single reflection surface is insufficient.

In some embodiments of the present disclosure, the beam relay/reflection device can also adjust the signal transmission frequency band, for example, arrange beams to be transmitted to the target object at a higher frequency band, so that the energy of the beams can be more concentrated and the signal transmission to the terminal can be enhanced.

It should be noted that considering that the beam source is a satellite, and the intelligent reflection surface is set on the top of a mountain, a building, HAPS or even an airplane, the distance between the intelligent reflection surface and the beam source is too far, such as hundreds to thousands of kilometers, so that only a small minority of beams emitted by the beam source can be received by the intelligent reflection surface and reflected to the target object. In this case, it is preferable to adopt a plurality of intelligent reflection surfaces to realize beam reception and reflection. Additionally, or alternatively, the beam source can transmit the beams at a higher frequency, such as tHz. Additionally, or alternatively, functions such as beam power strengthening can be realized on the intelligent reflection surface to improve beam reflection.

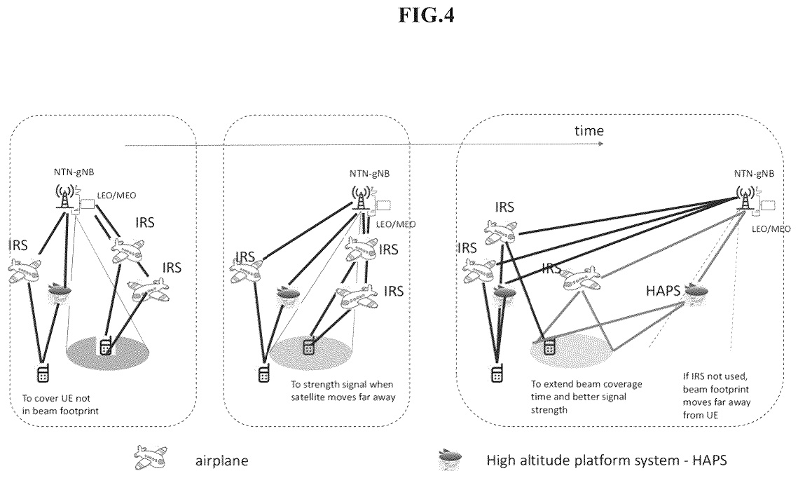

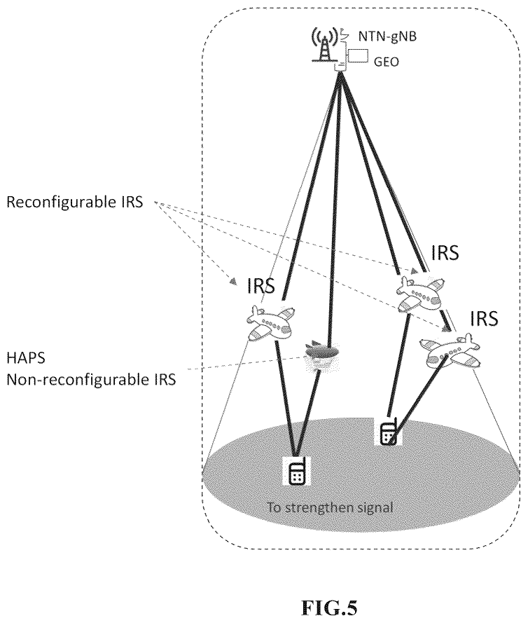

FIGS. 4-7 schematically illustrate examples of applying intelligent reflection surfaces to achieve coverage for a target area and/or a target terminal according to an embodiment of the present disclosure.

As shown in FIG. 4, there are two terminals in the leftmost diagram, one of which is in a beam footprint of a base station in a non-terrestrial network, and the other is out of the footprint of the base station in the non-terrestrial network, possibly due to the occlusion of mountains or buildings. Intelligent reflection surfaces installed on airplanes, high-altitude platforms, hilltops and building-tops can be used to reflect the signals from the base station of the non-terrestrial network to uncovered areas. Meanwhile, the intelligent reflection surfaces can be further used to perform signal strengthening for the terminal that has been covered by the beams from the base station, so that, as shown in the middle diagram of FIG. 4, the terminal for which signal strengthening is performed by the intelligent reflection surfaces can still have better received signal quality, even when the satellite moves far away from the terminal. As shown in the right diagram of FIG. 4, due to the movement of the satellite/high-altitude platforms, etc., the beam footprint of the base station should move along with it, so that the originally covered terminal loses the coverage by the current serving base station. By using the intelligent reflection surfaces, the signals from the serving base station can be reflected to continue to cover the area covered by the original beams, which can extend the beam coverage duration of the serving base station for the area.

As shown in FIG. 5, the GEO satellite is relative far away from the earth, and the signal received by the terminal on earth is relatively weak, due to the power limitation, the terminal uplink signals received by the GEO satellite are relatively weak, so the intelligent reflection surfaces can be installed on airplanes, high-altitude platforms or even LEO or MEO satellites to enhance the reception of uplink signals and downlink signals.

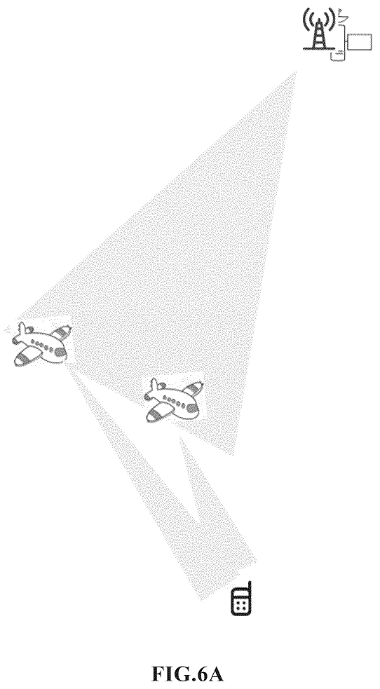

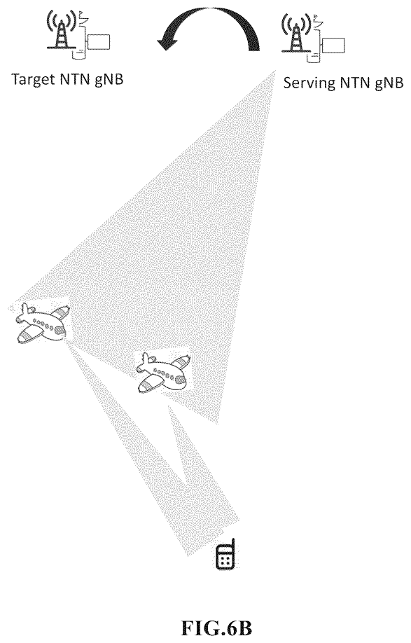

FIGS. 6A and 6B show schematic diagrams of utilizing a plurality of intelligent reflection surfaces to reflect beams to strengthen the signals received by the terminal in an NTN network. FIG. 6A shows that in the NTN network, the intelligent reflection surfaces installed on the flight equipment can be used to reflect the beams to the terminal device, thereby enhancing the signal strength of the terminal device. FIG. 6B shows that when the NTN base station serving the terminal device is handed over, the intelligent reflection surfaces installed on the flight equipment can still be used to reflect the beams to the terminal device, thus enhancing the signal strength of the terminal device.

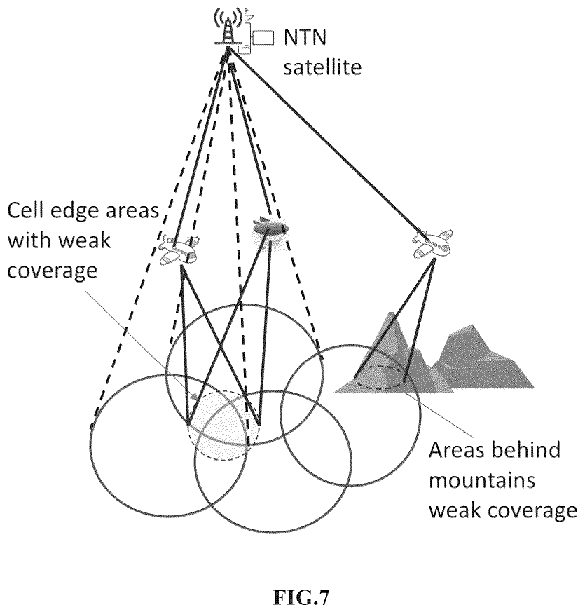

FIG. 7 shows a schematic diagram of using intelligent reflection surfaces to reflect beams to cover a multi-cell boundary area and an occluded area in a NTN network according to an embodiment of the present disclosure. As shown in FIG. 7, in the NTN network, the signal coverage of the base station is relatively weak in some areas, such as the back of high mountain (relative to satellite/high-altitude platform base stations), a building occluded area, and an overlapping area of multiple beam footprints of multiple satellite/high-altitude platform base stations. The present disclosure proposes to use intelligent reflection surfaces to reflect NTN base station beams to cover a target area, where there may not always be terminals. In the present disclosure, a plurality of intelligent reflection surfaces can be used to cooperate with each other to cover the same area.

According to an embodiment of the present disclosure, the beam relay/reflection setting information of the beam relay/reflection device may be set in advance, for example, it may be said to be relatively fixed. For example, in a case that the beam relay/reflection device is an intelligent reflection surface, the position and reflection orientation of the intelligent reflection surface may be preset, for example, the intelligent reflection surface may be arranged on the top of a mountain or a building.

According to an embodiment of the present disclosure, the beam relay/reflection setting information of the beam relay/reflection device may be configurable, for example, it may be said to be adjustable. For example, in a case that the beam relay/reflection device is an intelligent reflection surface, the reflection orientation of the intelligent reflection surface can be adjusted; Or in the case that the intelligent reflection surface is installed on an adjustable platform or flight equipment, the position of the intelligent reflection surface can also be adjusted. In particular, the beam transmission configuration can be adjusted according to the configuration of the target object, so that the beam can be transmitted to the target object more appropriately, that is, the beam relay/reflection device can match the target object more appropriately.

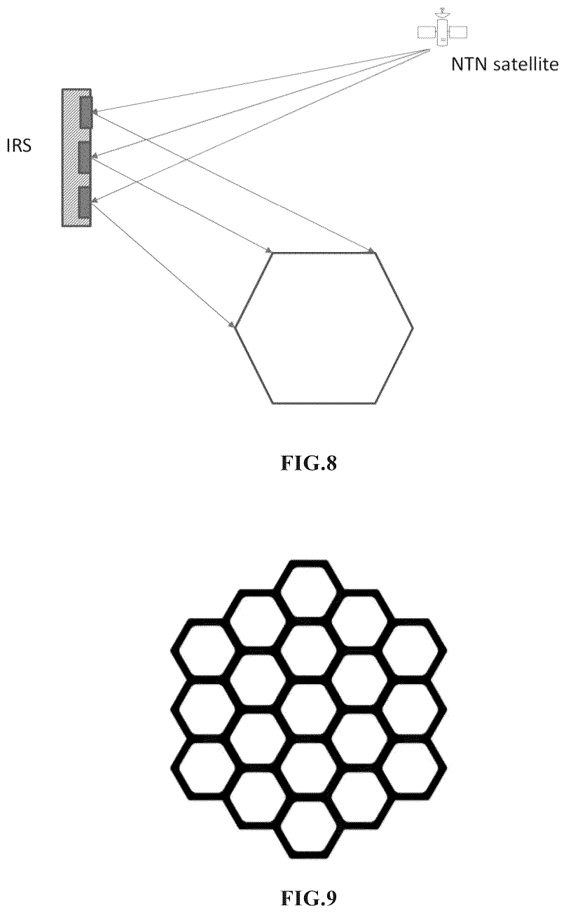

In some embodiments of the present disclosure, NTN base station signals can be reflected by intelligent reflection surfaces to cover a target area, especially a target cell. In particular, under the control of software, each reflection unit of the intelligent reflection surface can implement reflection in a different direction, and the reflection angle of each reflection unit can be controlled based on its own altitude, orientation, geographical location, and geographical location and size of the target coverage area, so as to finally cover the target cell, as shown in FIG. 8.

According to an embodiment of the present disclosure, the target area may include at least one sub-area, and for each sub-area, at least one beam relay/reflection device may be similarly provided. For example, at least one beam relay/reflection device can be set by the control-side device in the non-terrestrial wireless communication network based on the setting information of the sub-area, for example, the intelligent reflection surfaces can be set as described above.

As an example, the target cell may be set in an appropriate manner. For example, first of all, a vast area on earth (such as a country, an area) can be divided into a certain number of continuous small areas, as shown in FIG. 9, each small area can have its own ID and have a size that is suitable to be covered by one intelligent reflection surface, such as a hexagon with a size of about 10 square kilometers. Secondly, each small area can be represented by a set of parameters, and the representative parameters of a hexagonal small area are {L_{g}, R, D, ID}, where L_{g} is the GPS coordinate of the center of the small area, R is the radius of the hexagon, D is the direction of the hexagon, and ID is the number of the hexagon. Here, each small area may serve as a target area/target cell in the context of the present disclosure, or may serve as a sub-area in the target area/target cell.

It should be pointed out that the above hexagonal cells or sub-areas are only exemplary, and cells/sub-areas of other shapes are also possible, as long as the whole area can be separated and combined from the areas on earth. An area of other shape may be represented by a different set of parameters. The parameter information of such areas can be stored in a system data center which can be accessed by NTN base stations. It should be noted that the operations and processing for the target area in the present disclosure can be equally applied to the sub-areas in the target area, and to some extent, a sub-area in the target area can also be regarded as a target area, which will not be described or distinguished in detail here.

According to an embodiment of the present disclosure, the target area may be fixed or mobile, and may be set in an appropriate manner. In some embodiments, when the target area is fixed, for example, the target cell in the target area can be set as described above.

In other embodiments of the present disclosure, in a case that the target area can be mobile, the target area or target cell, to which beam transmission is to be performed by the beam relay/reflection device, can be set in an appropriate manner, especially can be set by dividing a mobile target area within a specific time interval. In particular, according to an embodiment of the present disclosure, when the target object is a mobile target area, the target area is an area corresponding to a specific time slot within a move time interval. And the move time interval can be continuously divided from a move time of the target area.

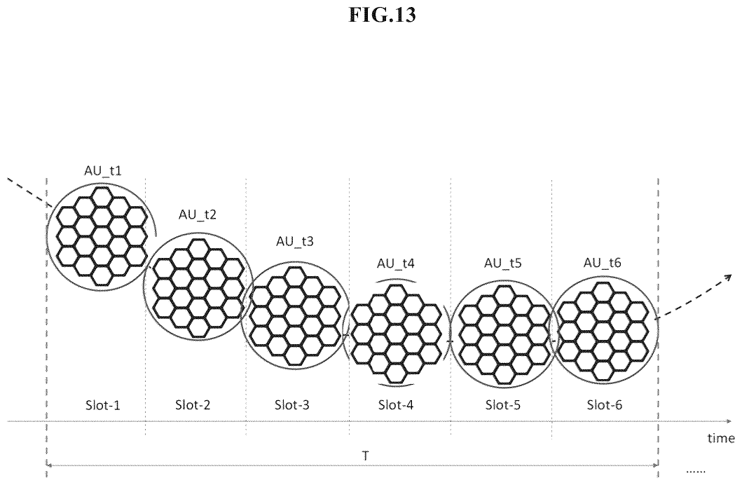

As an example, as shown in FIG. 13, the present disclosure proposes to divide time into continuous time intervals, each time interval has a duration of T, and each time interval can be further divided into N time slots. It can be assumed that the area required for reflection coverage in each time slot is fixed. The serving NTN base station can analyze target small areas that need to be covered in each time slot in a time interval, and records them as a set of time slot small areas AU_ti={AU1_ti, AU2_ti, AU3_ti, . . . }, i=1, . . . ., N. For each small area in the set, the NTN base station regards it as a stationary small area, so for each AU_ti, the NTN base station sends the parameters of the set of target small areas in a time interval T, together with related parameters such as the coverage start time and end time, to a selected intelligent reflection surface, so that the intelligent reflection surface can reflect the beams to an appropriate target small area at an appropriate time.

According to an embodiment of the present disclosure, in a case that there is a plurality of operable beam sources, it is still possible to set or select the beam relay/reflection device for beam reception and transmission in consideration of the coverage overlapping condition between the beam sources. In some embodiments, the coverage overlapping areas in different time slots can be determined based on the setting information of a current beam source and an adjacent beam source, and the beam relay/reflection device can be determined based on the coverage requirements of the overlapping areas in different time slots, so as to transmit the beams from the beam source to the target object. Particularly, when the current beam source and the adjacent beam source are satellite beam sources, such as NTN base stations, ephemeris information of the current beam source and the adjacent beam source can be acquired as the setting information. As an example, the control-side device can obtain the ephemeris information through a Xn interface, and of course, can also obtain the ephemeris information through other appropriate interfaces. In some examples, where the beam source can be handed over, the adjacent beam source may be a next beam source to be handed over from the current beam source.

According to an embodiment of the present disclosure, in a case that the target object corresponds to the terminal device, the beam relay/reflection device may also set the beam relay operation based on setting information of the terminal device. In particular, the setting information of the terminal device may include at least one of location of the terminal device, beam receiving setting information, and the like, so that the beam relay/reflection device can accurately and appropriately track the terminal device based thereon, so that the transmission configuration of the beam relay/reflection device can be optimized.

In some embodiments of the present disclosure, the beam receiving configuration of the terminal device may be, for example, the beam receiving direction or the like, and can be set in an appropriate manner. In particular, the terminal device can determine its appropriate beam receiving configuration, such as beam receiving direction, by performing beam measurement. Particularly, during movement of the terminal device, the beam receiving direction of the terminal device can be determined by beam measurement between the terminal device and the beam source, and then can be informed to the beam relay/reflection device, so that the beam relay/reflection device can properly adjust its beam transmission so as to transmit the beams to the terminal device more accurately and appropriately.

In some embodiments of the present disclosure, the setting information of the terminal device can be acquired by the control-side device and informed to the beam relay/reflection device. In particular, the control-side device can acquire the setting information of the terminal device periodically or on demand. In some examples, the terminal device may report its setting information to the control-side device, for example, periodically.

In some embodiments, the reporting period of the setting information of the terminal device, especially the location information, can be determined based on the location information or motion condition of the beam source and the location information or motion condition of the terminal device. In some examples, it can be determined based on a relative positional relationship between the beam source and the terminal device. For example, the closer the terminal device is to the edge of the coverage area of the beam source, the shorter the reporting period is; otherwise, the closer it is to the center of the coverage area of the beam source, the longer the reporting period is. In other examples, it can be determined based on ephemeris or movement condition of the beam source, including movement speed, movement direction, etc. For example, if the movement direction of the terminal device is consistent with the movement direction of the beam source, the reporting period will be long, otherwise, the smaller the relative speed is, the shorter the reporting period is. The smaller the relative speed between the terminal device and the beam source is, the longer the reporting period is; otherwise, the larger the relative speed is, the shorter the reporting period is.

According to an embodiment of the present disclosure, the beam relay/reflection device can also transmit beams to the target object according to the beam transmission setting information, so as to realize the beam coverage for the target object. In some embodiments, the beam transmission setting information may include time information about the beam transmission to the target object.

According to an embodiment of the present disclosure, the processing circuit of the beam relay/reflection device may be further configured to acquire time information of beam transmission from the beam relay/reflection device for a target object, and configure beam transmission of the beam relay/reflection device based on the beam transmission time information, to perform beam transmission within a time specified by the time information to transmit beams to the target object. In some embodiments, the time information may include a start time and an end time, for example, coverage start time and end time. In this way, performing beam transmission within the time specified by the time information to transmit beams to the target object includes starting beam transmission to the target object at the start time and stopping beam transmission to the target object at the end time.

According to an embodiment of the present disclosure, the time information of beam transmission can be determined in various appropriate ways. In particular, in some embodiments, an appropriate beam reflection start time and beam reflection end time can be determined based on respective setting information of the beam relay/reflection device and the target object, especially based on the relative situation between the beam relay/reflection device and the target object, such as the reflection configuration of the intelligent reflection surface, such as the reflection angle range, information about relative position between the intelligent reflection surface and the target object, change situation of the relative position, etc., so that it can be determined that the beam relay/reflection can be used to implement beam coverage for the target object in this specific time period. In some embodiments, the time information of beam transmission can be determined by any appropriate device in the network. For example, it can be set by the control-side device, such as based on the above information. Alternatively, it can also be set by other devices in the network and acquired by the control-side device from other devices in the network.

According to embodiments of the present disclosure, the beam relay/reflection device may also cooperate with the beam source in order to improve beam transmission of the beam emitted by the beam source via the beam relay/reflection device. In particular, the operation of one of the beam relay/reflection device and the beam source can be performed based on the setting information of the other of the beam relay/reflection device and the beam source, so that the operations of both the beam relay/reflection device and the beam source can match better, and the beam transmission and reception can be further optimized. The setting information interaction between the beam source and the beam relay/reflection device can be performed in various appropriate ways, for example, via an appropriate device in the network, such as a control-side device, or can even be performed directly.

In some examples of the present disclosure, the processing circuit of the beam relay/reflection device may be further configured to acquire setting information of a beam source and configure the beam relay/reflection device based on the setting information of the beam source to receive beams transmitted from the beam source.

In particular, the setting information of the beam source may include at least one of spatial location information and beam emission parameters of the beam source. The spatial location information of the beam source includes at least one of the geographical location of the beam source and the spatial trajectory of the beam source. The beam emission parameters include at least one of the beam direction of the beam source, the antenna radiation pattern of the beam source. As an example, in a case where the beam source is a satellite, the setting information of the beam source may include the geographical location, the satellite beam direction, the radiation pattern of the satellite antenna, the satellite ephemeris, which can be used as an example of the spatial trajectory of the beam source, or the like of the satellite. Thus, the operation of the beam relay/reflection device can be configured based on such setting information.

In some embodiments, configuring the beam relay/reflection device based on the setting information of the beam source includes adjusting the beam reception setting of the beam relay/reflection device so as to match the beam transmission settings of the beam source. Therefore, the beams from the beam source can be received more appropriately.

As an example, the reception setting of the beam relay/reflection device can be set based on the beam direction of the satellite appropriately, so that the beam relay/reflection device can accept the setting, for example, a receiving angle of a receiving component matches the beam direction, so that a beam from the transmitting source can be received more appropriately. As another example, an ephemeris of a satellite may correspond to a spatial trajectory of the satellite. In this way, based on the spatial trajectory of the satellite, the reception setting of the beam relay/reflection device can be adjusted dynamically, especially a sequence of reception settings can be set, so that the reception setting, such as the receiving angle of the intelligent reflection surface, can be adjusted dynamically with the movement of the satellite.

In some embodiments, the acquiring the setting information of the beam source may include acquiring the setting information of the beam source periodically from the control-side device, or sending a request to the control-side device and acquiring the setting information of the beam source provided by the control-side device as acknowledgement, or even directly acquiring, for example, directly periodically acquiring or requesting to acquire, the setting information from the beam source,.

It should be noted that, alternatively, the setting of the beam relay/reflection device may also be controlled and executed by the control-side device. For example, the control-side device can optimize the setting of the beam relay/reflection device based on the setting information of the beam source, and then inform the beam relay/reflection device of the optimized setting information so that the beam relay/reflection device can be set correspondingly.

In other embodiments, the beam source can also acquire the setting information of the beam relay/reflection device, so that the beam source can adjust its beam emission based on the setting information of the beam relay/reflection device.

In some embodiments, the processing circuit of the beam relay/reflection device may be further configured to inform the control-side device of the setting information of the beam relay/reflection device, wherein the beam source sets beam emission based on the setting information of the beam reflection device to transmit beams to the beam relay/reflection device. As an example, a beam source suitable for the beam relay/reflection device can be selected based on the location, receiving angle, etc. of the beam relay/reflection device, and the beam emission direction of the beam source can be adjusted based on the receiving angle of the beam relay/reflection device, so that the beam source can emit the beams toward the beam relay/reflection device more accurately.

Here, the adjustment of the beam source can be realized via the control-side device. As an example, the control-side device may acquire the setting information of the beam relay/reflection device, and determine the configuration of a matched beam source accordingly, and then inform the beam source of the determined setting information of the beam source, so that the beam source can perform beam emission accordingly. As another example, the setting information of the beam relay/reflection device can be informed to the beam source directly or via the control-side device, so that the beam source can perform beam emission based on the information accordingly.

According to an embodiment of the present disclosure, the setting information of the beam relay/reflection device and the setting information of the beam source can be interacted in an appropriate manner. As an example, interaction can be performed at specific intervals, such as periodically. As another example, it is also possible to interact upon request. For example, transmission can be performed upon the request of the control-side device. For example, the beam relay/reflection device may request to acquire the setting information of the beam source, and the beam source may request to acquire the setting information of the beam relay/reflection device.

In some embodiments, the setting information interaction between the beam source and the beam relay/reflection device can be carried out at specific time intervals or upon request within a beam transmission period indicated by beam transmission time information, so that the cooperation between the beam source and the beam relay/reflection device can be further improved in the beam transmission process, so that the transmission and reception of the beams are more accurate. In other embodiments, it is also possible to perform the setting information interaction before the beam transmission period indicated by the beam transmission time information, and to perform optimized beam emission and receiving by applying the adjusted setting information of the beam source and the beam relay/reflection device during the beam transmission period.

In an embodiment of the present disclosure, the setting information of the beam relay/reflection device and/or the beam source can also be uploaded to a network and stored in an appropriate location. As an example, it can be stored in a core network, and then be informed by the core network to the base station; or can directly informed to both the base station and the core network; or can be informed to the base station, and then can be informed to the core network when the base station interacts with the core network. As an example, in this case, the interaction between the beam source and the beam relay/reflection device can be turned on by the control-side device periodically or upon request, and in particular, the setting adjustment of the beam source and/or the beam relay/reflection device can be made by the control-side device itself periodically or upon request, and then the adjusted setting can be informed to the beam source and/or the beam relay/reflection device.

In an embodiment, a beam relay/reflection device can register its setting information with the network, so that during communication, an appropriate device in the network, such as a control-side device, can acquire the setting information of the beam relay/reflection device, so as to perform corresponding operations based on the setting information of the beam relay/reflection device, such as determining the beam relay/reflection device for beam transmission to a target object, and informing the beam source of the setting information of the beam relay/reflection device to optimize beam emission of the beam source.

According to an embodiment of the present disclosure, the registration of the beam relay/reflection device can be performed in an appropriate manner. In particular, the setting information of the beam relay/reflection device, such as location information, identification information, operation parameters, etc. of the beam relay/reflection device, can be registered in the network. The operation parameter information may include operation time, performance parameters or the like of the beam relay/reflection device. Each beam relay/reflection device can be assigned a unique identification account (ID). For example, in a case that the beam relay/reflection device includes a plurality of sub-devices, each sub-device may be assigned a unique identification account. For example, each intelligent reflection surface can be assigned a unique ID, and when each intelligent reflection surface includes multiple sub-reflection surfaces, each sub-reflection surface is also assigned a unique ID.

According to an embodiment of the present disclosure, the registration of the beam relay/reflection device can be performed by the beam relay/reflection device itself, for example, the beam relay/reflection device can register its own setting information into the network. In other embodiments, the registration of the beam relay/reflection device may be performed by other parties, such as an operator, a provider, etc.

According to an embodiment of the present disclosure, the setting information of the beam relay/reflection device and/or the beam source can be registered at an appropriate time. As an example, it can be registered in the initialization stage, for example, it can be informed to at least one of the NTN base station and the core network in the initialization stage. As another example, the setting information of the beam relay/reflection device and/or the beam source can also be updated and informed to at least one of the NTN base station and the core network during the system operation, for example, it can be updated and informed periodically, or it can be informed upon the request of the base station and the core network.

### EXEMPLARY EMBODIMENTS

A target object beam transmission implemented via a beam relay/reflection device according to an embodiment of the present disclosure will be described below. In particular, the target object may include a target area, a target terminal, etc., and the target area may be a fixed area or a mobile area, and the target terminal may include a fixed terminal or a mobile terminal, etc. For various types of target objects, corresponding operations of target object beam coverage will be described in detailed hereinafter.

An implementation according to the present disclosure will be described below with an intelligent reflection surface as an example of a beam relay/reflection device. It should be pointed out, however, that the conceptual implementation of the present disclosure can be equivalently applied to other types of beam relay/reflection devices.

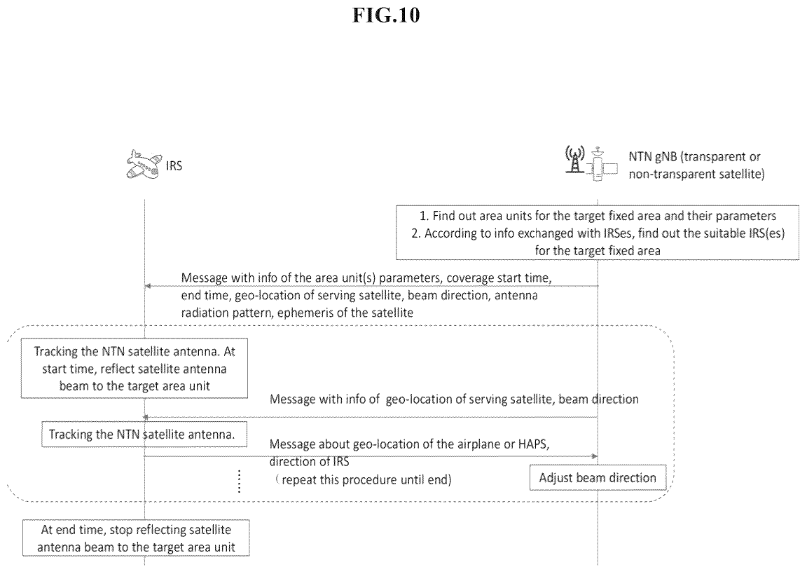

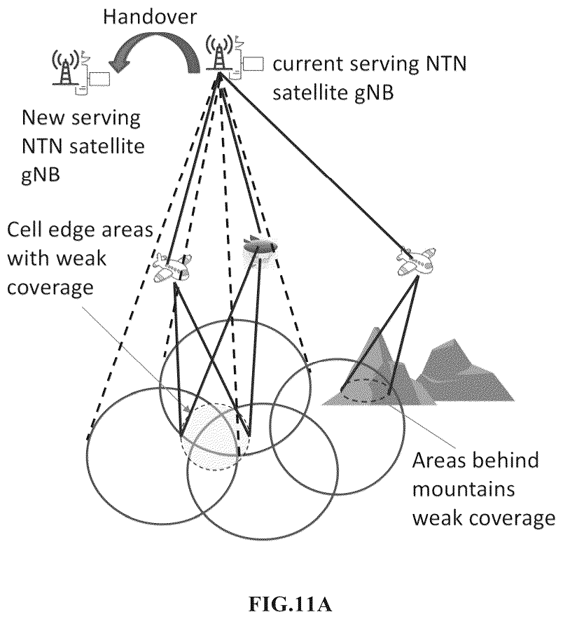

FIG. 10 shows a flow chart of reflecting beams with intelligent reflection surfaces to cover a fixed target area according to an embodiment of the present disclosure. Especially, in the embodiment, the target area covered by the beams reflected by the intelligent reflection surfaces is a fixed area on earth.

According to an embodiment of the present disclosure, the beam source can transmit beams based on the control by a control-side device in the non-terrestrial wireless communication network. In particular, as an example, the control-side device may be a base station. The base station and the beam source can be set in various suitable ways.

In some embodiments, the beam source may be integrated with a control-side device (e.g., a base station) in the non-terrestrial wireless communication network. As an example, when the beam source is a satellite, the base station can be integrated with the satellite to form an NTN base station. The following will be described based on this situation.

First, the NTN base station finds out relevant parameters of an area to be covered. In particular, the area to be covered can be divided into a plurality of small areas (also called area units) as described above, and the parameters of each small area, such as location parameters, size parameters, etc., can be provided to the base station in advance. As an example, the division of the area to be covered can be performed in advance and relevant parameters can be acquired and stored in advance, for example, in a memory, so that the base station can acquire the parameters of the area therefrom. As another example, the division of the area to be covered can be performed at the beginning of communication, so that the base station can acquire the relevant parameters of the area for communication after the division of the area.

Secondly, for each small area in the fixed area, the base station finds out one or more possible intelligent reflection surfaces that can cover the small area by reflection. The determination of intelligent reflection surfaces can be based on the location parameters, size parameters, etc. of the small area, and alternatively or additionally, intelligent reflection surfaces suitable for the small area, such as one or more intelligent reflection surfaces, can be selected based on the setting information of intelligent reflection surfaces themselves, such as the reflection configurations, locations, etc. of the intelligent reflection surfaces. Such determination can be performed as described above and will not be described in detail.

Then, the NTN base station provides parameters related to reflection beam coverage for the target area to intelligent reflection surfaces. In particular, for each selected intelligent reflection surface, the base station sends it parameters of a small area that needs reflection coverage by the intelligent reflection surface. Each selected intelligent reflection surface may cover one or more small areas. The parameters sent by the base station to each selected intelligent reflection surface may also include the time when the reflective coverage starts and the time when the reflective coverage ends for a specified small area, so that the intelligent reflection surface can realize the beam coverage for the target area based on the above information. For example, the reflection beam coverage for the target area can be performed within a time range defined by the coverage start time and the coverage end time, in particular, at the reflection coverage start time, the intelligent reflection surface starts to reflect the satellite antenna beams to the target area, and the beam reflection will not stop until the end time.

In addition, the base station can also provide some possible parameters to the selected intelligent reflection surface, including a geographical location of a satellite/high-altitude platform base station, a beam direction of the satellite/high-altitude platform base station, an antenna radiation pattern of the satellite/high-altitude platform, and an ephemeris of the satellite, so as to further optimize the reception and reflection of beams. Especially, in the reflection coverage operation, a NTN satellite antenna beam can be tracked based on relevant information of a NTN base station, such as the geographical location of the serving satellite/high altitude platform base station, the beam direction of the satellite base station, the antenna radiation pattern of the satellite base station and the satellite ephemeris. For example, when the satellite is moving, the intelligent reflection surface adjusts its reflection units as needed, so as to always reflect the signal from the satellite/high altitude platform.

In addition, during the beam reflection coverage, the NTN base station and the intelligent reflection surface can carry out information interaction therebetween. Specifically, the serving NTN base station can send its own geographical location and beam direction to the intelligent reflection surface at certain time intervals. Based on such information, the intelligent reflection surface can keep tracking the NTN satellite antenna beam to receive the satellite antenna beam properly. Meanwhile, the intelligent reflection surface also reports its geographical location and orientation to the serving NTN base station, especially when the intelligent reflection surface is installed on a mobile carrier such as an airplane. Upon receiving the location of the intelligent reflection surface, the serving NTN base station can also adjust the beam direction if necessary, so that the beam from the NTN base station can be better received by the intelligent reflection surface. The above interaction flow can be maintained until reflection coverage by the intelligent reflection surface for the small area ends.

In some embodiments, the beam source is separated from a control-side device in the non-terrestrial wireless communication network. As an example, a satellite as a beam source is separated from a base station as the control-side device, and such a satellite may be called a transparent satellite, and in particular, the base station may be a control-side device or a base station in a core network. In this case, the base station can communicate with the beam source via the core network to control the beam emission of the beam source. In addition, the base station can also communicate with the beam relay/reflection device and even the terminal device via the core network, and even can realize the information interaction between the beam relay/reflection device and the beam source. In this case, it is still possible to reflect the beams with the intelligent reflection surfaces to cover the fixed target area as described above, which will not be described in detail here.

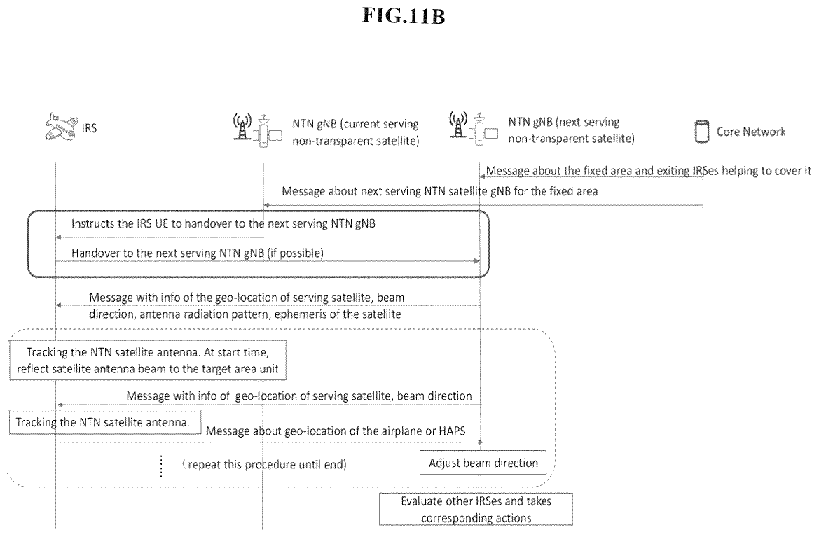

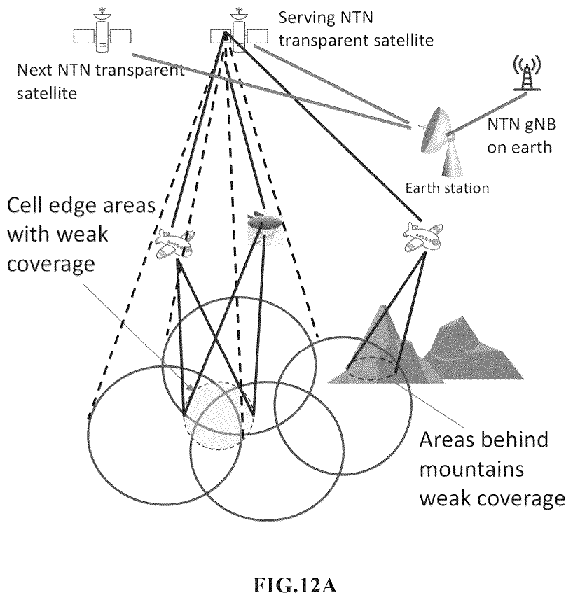

In an embodiment of the present disclosure, when a satellite beam is reflected by an intelligent reflection surface, due to the movement of the serving satellite, the intelligent reflection surface covering a certain area needs to be switched to the next serving satellite base station, as shown in FIG. 11A. In the following, an implementation of reflecting the beams via the intelligent reflection surface to cover the target area in the case of satellite handover will be described in detail with reference to an embodiment. It should be noted that such a handover operation may be performed in different ways depending on the different configurations of the beam source and of the base station.

In some embodiments, when the beam source is integrated with the control-side device, such as when the satellite is integrated with the base station, such as when the base station is deployed on the satellite, it can be called a non-transparent satellite base station. FIG. 11B shows a flowchart of an NTN network using a non-transparent satellite utilizes an intelligent reflection surface to reflect beams to cover a fixed area according to an embodiment of the present disclosure. Among them, when the non-transparent satellite base station serving NTN is far away from the area covered by the intelligent reflection surface, another satellite base station close to the area covered by the intelligent reflection surface can be arranged as a new serving satellite base station to replace the far-away serving satellite base station (which can be called the current serving satellite base station and the old serving satellite base station), and such the next serving satellite base station (which can also be called the new serving satellite base station) can be set by the core network.

First, the core network informs the new serving satellite base station of parameters of all small areas in this area and parameters of the intelligent reflection surface that has covered this area by means of reflection. In addition, the core network also informs the current serving satellite base station of the parameters of the new serving satellite base station.

Secondly, if possible, the current serving satellite base station guides the intelligent reflection surface to switch to the new serving satellite base station. As an example, the current serving NTN satellite base station instructs the intelligent reflection surface, that provides reflection coverage for the target area, to switch to the next serving NTN satellite base station, for example, the parameters of the next serving NTN satellite base station can be provided to the intelligent reflection surface, and if possible, the intelligent reflection surface can switch to the next serving NTN satellite base station according to the parameters. Therefore, the intelligent reflection surface can receive beams from the next serving NTN satellite base station and reflect the beams to the target area.

In addition, information interaction can be performed between the new serving satellite base station and the intelligent reflection surface. In particular, the new serving satellite base station informs its own parameters such as geographical location, beam direction, antenna radiation pattern, satellite ephemeris and other information to the intelligent reflection surface, so that the intelligent reflection surface can optimize its receiving configuration based on the parameters of the new serving satellite base station, for example, it can adjust its receiving configuration, such as receiving angle, so that it can more appropriately match the new serving satellite base station to receive beams from it.

As an example, the intelligent reflection surface tracks an antenna beam of the next NTN serving satellite base station and reflects the antenna beam of the next NTN serving satellite base station to a target small area at a predetermined time; for example, the next NTN serving satellite base station will inform the intelligent reflection surface of its geographical location and beam direction at regular intervals; therefore, the intelligent reflection surface can track the beam of the updated next NTN serving satellite base station according to the geographical location and beam direction of the next NTN serving satellite base station.

As another example, the intelligent reflection surface can also inform a NTN serving satellite base station, especially the next NTN serving satellite base station, of its setting information. In particular, the setting information of the intelligent reflection surface may include the location of the intelligent reflection surface, the angle of the intelligent reflection surface, or the like. In this way, the NTN base station can adjust its emission operation based on the setting information of the intelligent reflection surface, for example, it can adjust its beam emission direction, so that it can best match the intelligent reflection surface, and the beam can be received by the intelligent reflection surface more appropriately.

The communication between the intelligent reflection surface and the NTN service can be performed in an appropriate manner, such as periodically, on demand, and so on. In particular, the communication between the intelligent reflection surface and the NTN service can be carried out between the time periods of beam reflection coverage.

In addition, the next satellite serving base station can also evaluate the possibility of using other intelligent reflection surfaces to cover the target area, and if there are appropriate intelligent reflection surfaces, such appropriate intelligent reflection surfaces can be used to cover the target area. Here, the determination and application of the appropriate intelligent reflection surfaces can be performed as described above, and will not be described in detail here.

In other embodiments of the present disclosure, a beam source such as a satellite is set separately from a control-side device such as a base station, which can be called a transparent satellite base station, wherein the base station can be deployed on earth, and the satellite only performs beam emission or forwarding. Here, the base station can be deployed in the core network.

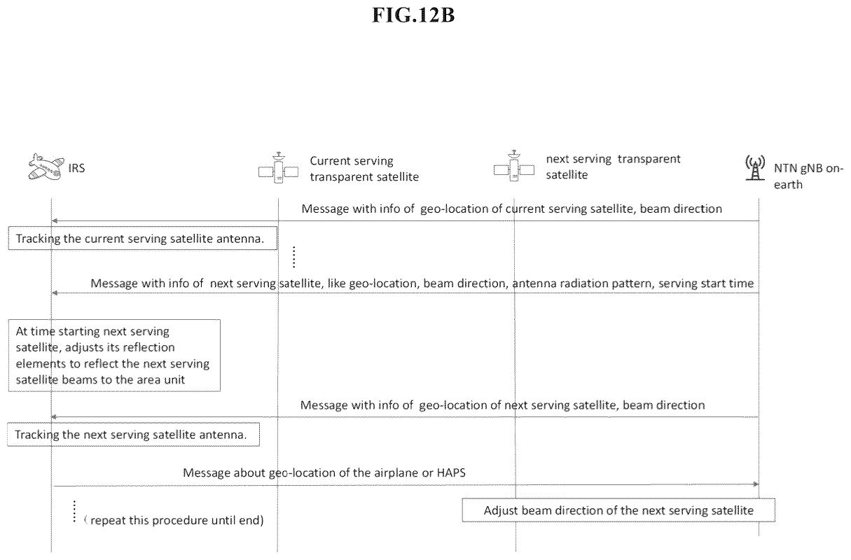

FIG. 12A shows a schematic diagram of serving base station handover when intelligent reflection surfaces are used to reflect beams to cover a fixed area in an NTN network using transparent satellites according to an embodiment of the present disclosure. FIG. 12B shows a flowchart of reflecting beams by using intelligent reflection surfaces to cover a fixed area in an NTN network using transparent satellites according to an embodiment of the present disclosure.

Especially, when a transparent satellite is far away from the reflection coverage area, the intelligent reflection surface needs to be paired with another transparent satellite that is responsible for covering the designated area, so as to continue to reflect the beams to cover the designated reflection coverage area. The NTN serving base station located on earth can inform the intelligent reflection surface of the parameters related to the next transparent satellite, which can be the beam source setting information as mentioned above, including but not limited to, for example, geographical location, beam direction, antenna radiation pattern, and the start time of starting to reflect the beam of the next transparent satellite. Therefore, at the scheduled start time of reflecting the beam of the next transparent satellite, the intelligent reflection surface starts to reflect the beam of the next transparent satellite to the target reflection coverage area.

Hereinafter, related operations of reflecting beams with intelligent reflection surfaces when using transparent satellites to cover a fixed area according to an embodiment of the present disclosure will be described in detail.

When the current serving transparent satellite is far away from a predetermined target area and a new transparent satellite is needed, a ground base station sends the parameters of a selected next transparent satellite, such as geographical location, beam direction, antenna radiation pattern, and the start time of starting to reflect the beam of the next transparent satellite, to the intelligent reflection surface. In this way, in the case of satellite handover, the intelligent reflection surface will be connected to the handed-over next transparent satellite, so that when starting to reflect the beam of the next serving satellite, the intelligent reflection surface can adjust its reflection units to reflect the beam of the next serving satellite to a predetermined area.

Moreover, the intelligent reflection surface can also adjust its beam receiving configuration based on the acquired parameters, so that it can receive the beam of the next serving satellite more appropriately for reflection. Particularly, during the operation of the intelligent reflection surface reflecting the beam of the next serving satellite, the NTN base station sends the parameters of the next serving satellite, such as geographical location and beam direction, to the intelligent reflection surface at certain time intervals; therefore, the intelligent reflection surface can continuously track the next serving satellite based on the acquired parameters, so that when the next serving satellite moves relative to the ground, its beam can be reflected to the predetermined area in time.

On the other hand, the intelligent reflection surface can also provide its parameters to the serving satellite, in particular, during the operation of the intelligent reflection surface reflecting the beam of the next serving satellite, the intelligent reflection surface also sends its own carrier geographical location, direction and other information as parameters to the NTN base station at certain time intervals, so that the next serving satellite can adjust its beam direction, and the intelligent reflection surface can better reflect the beam to the predetermined area.

The above operations can be continuously repeated, until the coverage for the predetermined area by the next serving satellite is finished.

In the description of the above embodiments, it is mainly described that the target area for beam coverage is a fixed area. It should be pointed out that in the application of beam reflection coverage, the target area can also be mobile, which is called mobile/moveable target area. Hereinafter, an operation of implementing the beam coverage for a mobile/moveable target area via a beam relay/reflection device according to an embodiment of the present disclosure will be described with reference to the drawings, in which an intelligent reflection surface is described as an example of the beam relay/reflection device.

In particular, the mobile/moveable target area can be any of a variety of appropriate areas. As an example, this area may be a boundary area between the satellite coverage areas. For example, when a target area of an intelligent reflection surface is a boundary area covered by several satellite beams, the boundary area will also move with movement of the satellite relative to the ground, so small areas contained in the target area will also change continuously, as shown in FIG. 13. At this time, the NTN base station needs to continuously learn the parameter information of the new small area. In addition, because a carrier on which the intelligent reflection surface is installed may be stationary relative to the ground (for example, it is installed on the top of a high mountain or a building), or its movement speed relative to the ground is relatively slower than that of the satellite relative to the ground (for example, it is installed on an airplane or a high-altitude platform), for the NTN base station, the intelligent reflection surface is to be continuously replaced.

For such a mobile/moveable target area, for example, a target area that moves in a specific time during operation, the present disclosure proposes to intercept a target area in a specific time segment and treat such a target area as a fixed area. In particular, the movement time period of the target area can be divided into multiple time segments, and it can be considered that the target area is relatively fixed during each time segment, so that the operation of providing beam reflection coverage to the fixed target area via an intelligent reflection surface can be performed as described above.

As shown in FIG. 13, the present disclosure proposes to divide time into continuous time intervals, each time interval has a length of T, and each time interval is further divided into N time slots. In each time slot, it is assumed that the area to be covered by reflection is fixed. The serving NTN base station analyzes the target small area to be covered in each time slot in a time interval, and records it as a time slot small area set AU_ti={AU1_ti, AU2_ti, AU3_ti, . . . }, i=1, . . . , N. The division of the target cell can be performed as described above, and will not be described in detail here. For each small area in the set, the NTN base station regards it as a stationary small area, so as to perform beam reflection on the small area via the reflection surface.

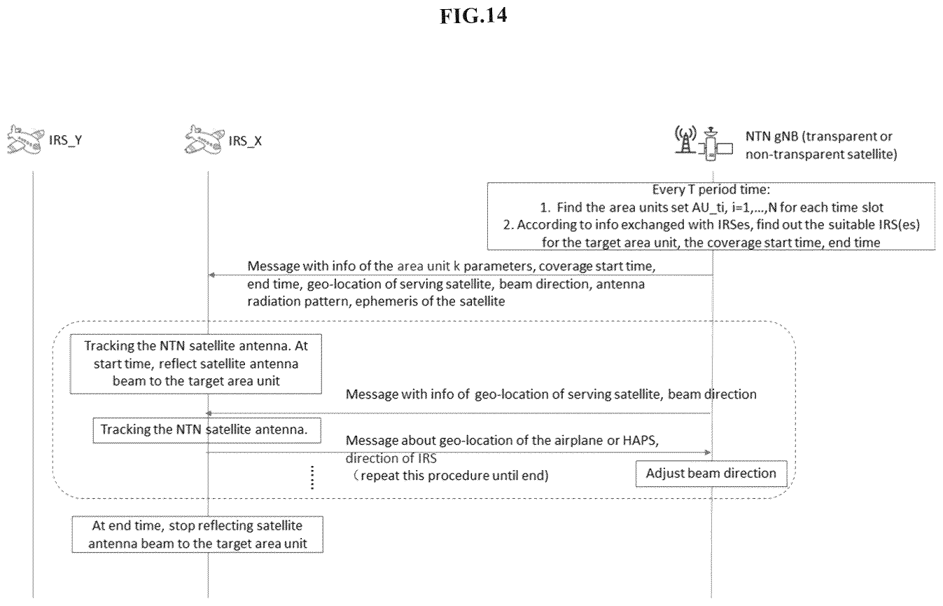

FIG. 14 illustrates an exemplary operation of implementing the beam coverage by an intelligent reflection surface for a mobile target area according to an embodiment of the present disclosure.

First of all, for every T time interval divided from a movement period, a NTN serving base station (whether using a transparent satellite or a non-transparent satellite) can determine the time slot small area set AU_ti, i=1, . . . , N; Then, based on interaction information with intelligent reflection surfaces, an appropriate intelligent reflection surface can be found for a target small area, and the start time and end time of reflection coverage for each small area can be determined. For example, each time slot small area can be determined as the target small area in time sequence with the movement.

Then, the NTN serving base station sends parameters of a target small area, including the location and size of the target small area k, the start time and end time of reflection coverage, and parameters related to a serving satellite, such as the geographical location, the beam direction, the antenna radiation pattern, the ephemeris of the serving satellite, etc., to the selected intelligent reflection surface. Therefore, the intelligent reflection surface can receive the antenna beams of the serving satellite, and start reflecting the beams of the serving satellite to cover the target small area k at the reflection coverage start time.

In addition, during communication, the NTN serving base station can also send the geographical location and beam direction of the serving satellite to the intelligent reflection surface, so that the intelligent reflection surface can continuously track the beams of the serving satellite during communication. On the other hand, if necessary, the intelligent reflection surface can also send its own geographical location and reflection direction to the NTN serving base station, so that the NTN serving base station can adjust its own beam direction as needed to send beams to the intelligent reflection surface more accurately, so that the beams can be better reflected to cover the small target area. The information interaction between the NTN serving base station and the intelligent reflection surface can be performed at certain time intervals or according to their respective requests. That is, it can be performed in an appropriate manner during the communication process, until the time period for the intelligent reflection surface reflecting beams to cover the target small area k ends.

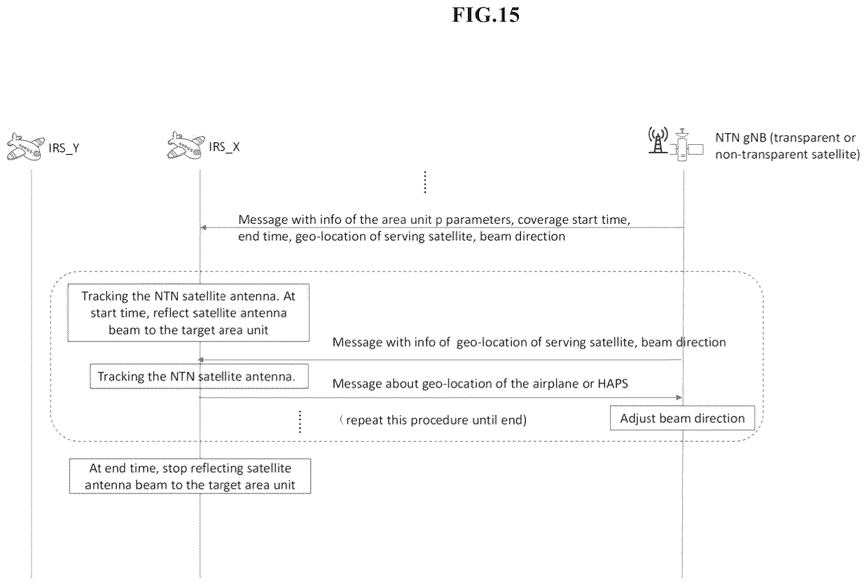

For other small target areas, such as the next small target area p, at the beginning of the time period corresponding to this small target area p, the above operations are repeated, as shown in FIG. 15, until all small target areas are covered by beam reflection.

In an embodiment of the present disclosure, the target object to be beam covered by the intelligent reflection surface can also be a terminal device, such as a terminal device in a specific cell, such as a UE, etc. In particular, the beams can be reflected to the terminal device via the intelligent reflection surface in order to realize signal strengthening. Hereinafter, an operation of realizing signal strengthening for a terminal device via a beam relay/reflection device according to an embodiment of the present disclosure will be described with reference to the drawings.

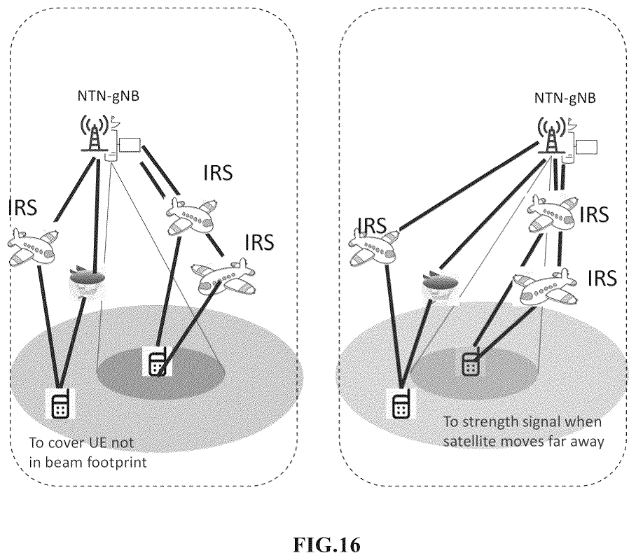

As shown in FIG. 16, we can use the intelligent reflection surface to strengthen signals received by a terminal that is not within the effective coverage of NTN downlink beams (left diagram). In addition, when the satellite is far away from the terminal over time, the intelligent reflection surface can also be used to strengthen the signals received by the terminal that will become weaker and weaker (right diagram). In this method, the terminal needs to report its geographical location to the NTN base station, the NTN base station will analyze the distribution of intelligent reflection surfaces and select an appropriate intelligent reflection surface to reflect and strengthen the received signals of the terminal. Meanwhile, the NTN base station will also inform the intelligent reflection surface of the location of terminal, so that the intelligent reflection surface can reflect the signals to the terminal.

In an embodiment of the present disclosure, similar to the case of the target cell, the terminal device is still involved in a case where the terminal device is fixed or mobile. In this way, according to whether the terminal device moves or not, it can be divided into two scenarios, and accordingly, the beam reflection by the intelligent reflection surface towards the terminal device can be performed.

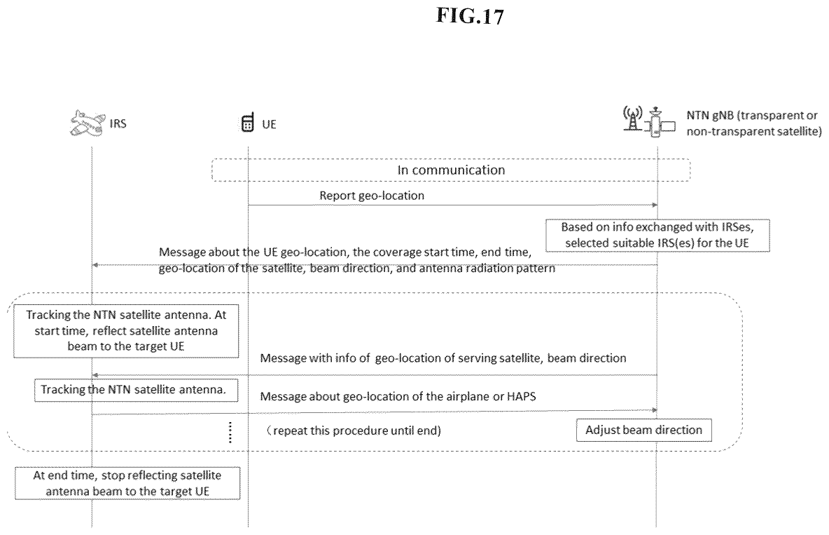

Next, with reference to FIG. 17, an exemplary operation of using intelligent reflection surfaces to realize beam coverage for a fixed terminal device according to an embodiment of the present disclosure in a scenario where the terminal device is fixed will be shown.

First, the terminal establishes communication connection with the NTN base station, and the terminal reports its geographical location to the NTN base station. The communication connection between the terminal and the NTN base station can be performed in various appropriate ways, which will not be described in detail here. Then, based on the information interacted with the intelligent reflection surfaces and the geographical location of the above terminal, the NTN base station can analyze and find out one or more intelligent reflection surfaces suitable for the terminal.

Then, NTN sends the terminal's geographical location, reflection start time, reflection end time, satellite's geographical location, beam direction, antenna radiation pattern, ephemeris and other information to the intelligent reflection surfaces, in this way, the intelligent reflection surfaces can track the satellite antenna beams, and reflect the satellite beams to the terminal at the predetermined reflection start time, so as to realize the signal strengthening for the terminal.

During the operation of reflecting the satellite beams to the terminal by the intelligent reflection surfaces, the information interaction between the terminal device and the satellite can be performed, in particular, at intervals, for example, via a NTN base station. On one hand, the satellite can send its own geographical location, beam direction and other information to the intelligent reflection surfaces at a certain time interval; in this way, the intelligent reflection surfaces can keep tracking the satellite beams according to the latest satellite information. Additionally, or alternatively, the intelligent reflection surfaces can send their own geographical locations to the NTN base station at a certain time interval, and then the NTN base station can control the satellite beam emission based on the positions of the intelligent reflection surfaces, so that it can adjust the directions of its transmitted beams to enable the intelligent reflection surfaces to better reflect the satellite beams to the target terminal. The information communication between the satellite and the terminal device can be performed until a predetermined reflection end time is reached.

An exemplary operation of using intelligent reflection surfaces to realize beam coverage for a fixed terminal device according to an embodiment of the present disclosure in a scenario where the terminal device is mobile will be shown hereinafter.

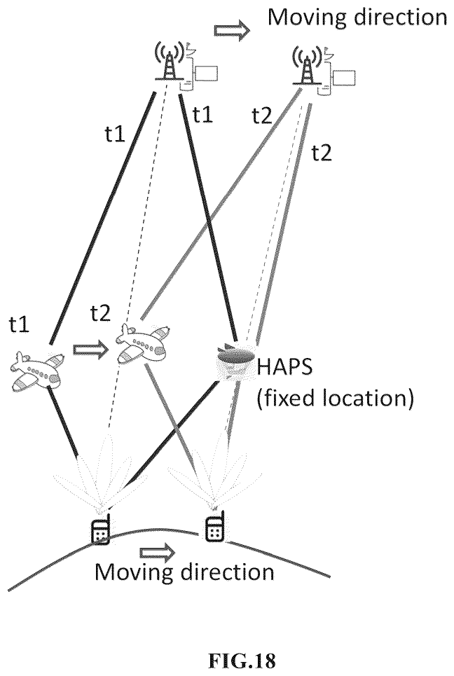

FIG. 18 shows a schematic diagram in a scenario where the terminal is in a mobile state. From time t1 to time t2, a satellite (LEO/MEO), carriers of intelligent reflection surfaces (such as airplanes) and a terminal will change their geographical locations. Because the direction in which the terminal moves is usually unpredictable for the NTN base station, the terminal may need to continuously inform the base station of its geographical location. In this way, the NTN base station needs to continuously inform the intelligent reflection surfaces of the new geographical location of the terminal, so that the intelligent reflection surfaces can continuously adjust their reflection directions. However, if the terminal moves at a very high speed, it is difficult for the intelligent reflection surfaces to track the terminal, so it is difficult to set their own reflection directions, and it is difficult for the NTN base station to predict the end time of reflection coverage. In view of this, the present disclosure further proposes that the NTN base station can use a beam direction obtained by a beam measurement process to provide the direction of reflection towards the terminal for the intelligent reflection surface and predict the reflection end time.

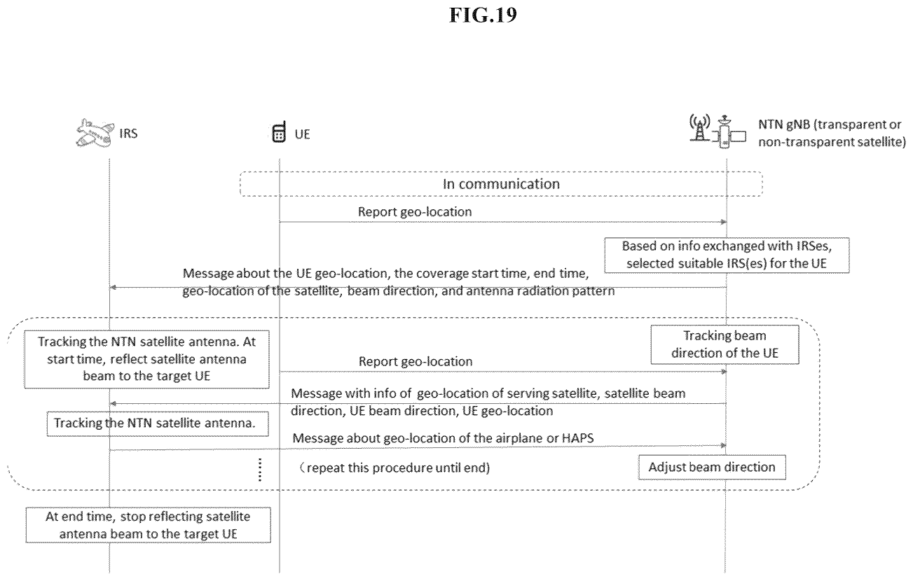

FIG. 19 shows a flowchart of using intelligent reflection surfaces to implement the beam coverage for a mobile terminal according to an embodiment of the present disclosure in a scenario where the terminal is mobile.

First, before the terminal moves, the terminal establishes communication connection with a NTN base station. Here, the terminal can report its geographical location to the NTN base station, and based on the information interacted with the intelligent reflection surfaces and the above geographical location of the terminal, the NTN base station can analyze and find out one or more intelligent reflection surfaces suitable for the terminal. Then, NTN sends the terminal's geographic location, reflection start time, reflection end time, satellite's geographic location, beam direction, antenna radiation pattern and ephemeris, or other information to the intelligent reflection surfaces. In this way, the intelligent reflection surfaces can track the satellite antenna beams and track the terminal, and reflect the satellite beams to the terminal at a predetermined reflection start time.

During the movement of the terminal, the NTN base station tracks the beam direction of the terminal through a beam measurement process for the terminal, so that it can instruct the intelligent reflection surface to provide more appropriate beam reflection for the terminal. In particular, the beam measurement can be performed at specific intervals or upon request during the movement of the terminal, so as to continuously track the beam direction of the terminal during the movement. The beam measurement can be triggered by the NTN base station or the terminal.

Then, during the intelligent reflection surface reflects the satellite beam to the terminal, the information interaction between the terminal and the satellite can be performed as described above. In particular, the terminal reports its geographical location to the NTN base station at certain time intervals; the NTN base station sends information such as satellite geographical location, satellite beam direction, terminal beam direction and terminal geographical location to the intelligent reflection surface; the intelligent reflection surface tracks the satellite beam and the terminal; if necessary, the intelligent reflection surface reports its geographical location to the NTN base station at a certain time interval, and this interaction can be carried out until a predetermined reflection end time is reached.

According to an embodiment of the present disclosure, the information of the intelligent reflection surfaces can be provided to the base station or even to the core network in an appropriate manner.

In particular, the information of the intelligent reflection surfaces can be registered or recorded in the base station, even in the core network, so that it can be applied when the beams are reflected by the intelligent reflection surfaces to cover the target area or the target terminal device. Specifically, the intelligent reflection surfaces may be installed on airplanes, high-altitude platforms, mountain tops or building roofs. The intelligent reflection surfaces need to be registered with the NTN base station, including their performance parameters, geographical locations, operation times, etc. The NTN base station can use such information to select an appropriate intelligent reflection surface for a specific area and terminal to be covered. Each intelligent reflection surface is assigned a unique identification account (ID).

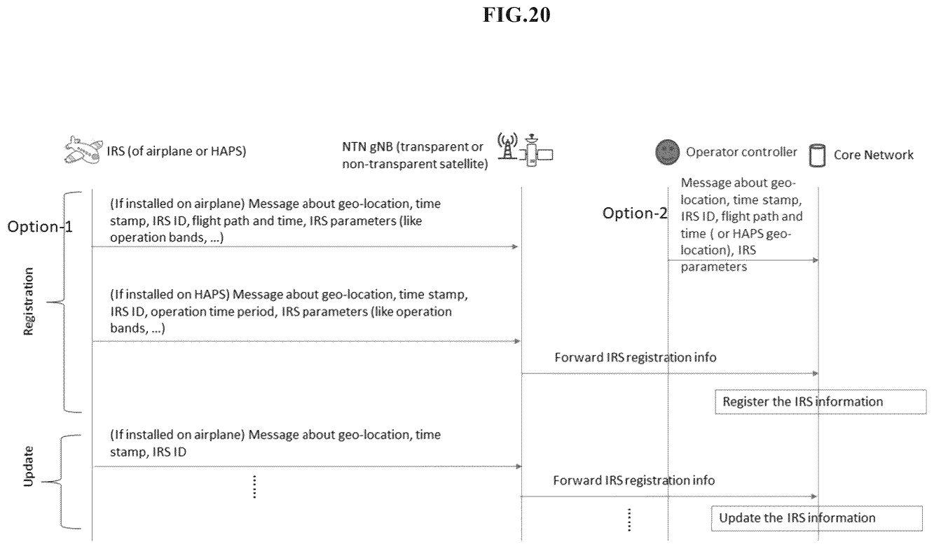

The interaction between the intelligent reflection surface and the NTN base station, especially the registration of information of the intelligent reflection surface can be performed in various appropriate ways, specifically, two registration modes can be adopted, as shown in FIG. 20.

The left side of FIG. 20 shows a first registration mode (option 1), in which the intelligent reflection surface itself can register or record its information into the NTN base station or even the core network. This registration or recording operation can be performed at the beginning of constructing a non-terrestrial network, and then can be dynamically updated during operation.

In one case, if the intelligent reflection surface is installed on a mobile carrier such as an airplane, the intelligent reflection surface sends its own geographical location, time stamp, identification account number (ID), flight trajectory and time (of the airplane or other), and parameters of the intelligent reflection surface (such as an operation frequency band) to the NTN base station.

In another case, if the intelligent reflection surface is installed on a stationary carrier such as a high-altitude platform, the intelligent reflection surface sends its own geographical location, time stamp, identification account number (ID), operational time period, and parameters of the intelligent reflection surface (such as an operation frequency band, etc.) to the NTN base station.

The NTN base station forwards the above information to the core network for registration.

If the above information changes, the intelligent reflection terminal sends new information to the NTN base station, and then the NTN base station forwards new information to the core network, and the core network updates the corresponding information.

On the right side of FIG. 20, the second registration mode (option 2) is shown, in which the operator registers and updates relevant information of the intelligent reflection surfaces to the core network. That is to say, the relevant information of the intelligent reflection surfaces can be provided to the operator in advance, or the operator can acquire the setting information of the intelligent reflection surfaces in advance and then provides it to the base station or even the core network.

Therefore, the relevant setting information of intelligent reflection surface can be used in network operation to select an appropriate intelligent reflection surface to participate in beam reflection coverage.

It can be seen from the above that the present disclosure proposes a method of using an intelligent reflection surface to reflect a beam from a beam source to cover a target area in a non-terrestrial network, which can at least strengthen the signals received by a terminal and prolong the time of the base station beam covering a cell. In particular, regardless of whether the target area is static (fixed) or dynamic (mobile), the coverage for the target area can be enhanced by using the intelligent reflection surface, including extending the coverage for the cell, enhancing the coverage strength for the cell, and the like. In this way, the intelligent reflection surface reflects the NTN base station beam to cover the target area and improve the coverage of the NTN network. Moreover, the intelligent reflection surface can reflect the NTN base station beam to the target area, prolong the service time of the cell and reduce the handover times.

On the other hand, according to an embodiment of the present disclosure, the intelligent reflection surface can also be used to strength the signals received by the terminal, regardless of whether the terminal is moving or not. In this way, the intelligent reflection surface reflects the NTN base station beam to the target terminal, which strengthens the signals received by the terminal, improves the communication quality and increases the channel capacity.

The beam relay/reflection device of the wireless communication system according to an embodiment of the present disclosure, especially its processing circuit, can be realized in various appropriate ways. In a structural example of the above device, the processing circuit may be in the form of a general-purpose processor or a special-purpose processing circuit, such as an ASIC. For example, the processing circuit can be constructed by a circuit (hardware) or a central processing device such as a central processing unit (CPU). In addition, the processing circuit can carry programs (software) for making the circuit (hardware) or central processing device to work. The programs can be stored in a memory (such as arranged in the memory) or an external storage medium connected from the outside, and downloaded via a network (such as the Internet).

According to some embodiments of the present disclosure, the processing circuit for the beam relay/reflection device may include various units for implementing the above operations accordingly. As shown in FIG. 3A, the processing circuit 302 of the beam relay/reflection device 300 may include a receiving unit 304 configured to receive a beam emitted from a beam source in the non-terrestrial wireless communication network, and a transmission unit 306 configured to transmit the received beam to a target object based on setting information of the target object, wherein the beam source is an aerial device capable of emitting beams in the non-terrestrial wireless communication network. It should be pointed out here that in a case that the beam relay/reflection device is an intelligent reflection surface as an example, the above processing circuit, the receiving unit and the transmission unit can be units for the intelligent reflection surface, or even be the intelligent reflection surface itself integrally. The receiving unit and the transmission unit can also be implemented integrally.

In some embodiments, the processing circuit 302 may further include an acquisition unit 308 configured to acquire time information of beam transmission to a target object, and the transmission unit 306 may perform beam transmission within a time specified by the time information of beam transmission.

In some embodiments, the acquisition unit may also acquire setting information of a beam source, and the processing circuit configures the beam relay/reflection device to receive beams from the beam source based on the setting information of the beam source. In particular, configuring the beam relay/reflection device may correspond to setting or adjusting the receiving configuration of the receiving unit, so as to receive the beams from the beam source more appropriately.

In some embodiments, the processing circuit may further include a sending unit 310 configured to inform the control-side device of the setting information of the beam relay/reflection device, so that the beam source can set beam emission based on the setting information of the beam reflection device to transmit beams to the beam relay/reflection device.

In some embodiments, when the beam source is integrated with the control-side device in the non-terrestrial wireless communication network and the beam source is handed over, the acquisition unit may acquire an instruction from the control-side device to handover to a new beam source, the receiving unit may receive beams from the new beam source, and the transmission unit may transmit the beams received from the new beam source to the target object.

In some embodiments, when the beam source is separated from the control-side device in the non-terrestrial wireless communication network and the beam source is handed over, the acquisition unit may acquire setting information from a new beam source, and the processing unit may configure the beam relay/reflection device based on the setting information of the new beam source to receive the beams from the new beam source. In particular, the receiving unit can be set or adjusted to properly receive beams.

Each of the above units can operate as described above and will not be described in detail here. It should be noted that the above-mentioned units are only logical modules divided according to their specific functions, and are not used to limit the specific implementation, for example, they can be implemented in software, hardware or a combination of software and hardware. In actual implementation, the above units can be realized as independent physical entities, or can also be realized by a single entity (for example, a processor (CPU or DSP, etc.), an integrated circuit, etc.). It should be noted that although units are shown as separate units in FIG. 3A, one or more of these units may be combined into one unit or split into multiple units. In addition, the above-mentioned units are shown by dotted lines in the drawings, indicating that these units may not actually exist, and the operations/functions they realize may be realized by the processing circuit itself.

It should be understood that FIG. 3A is only a schematic structural configuration of the beam relay/reflection device in the wireless communication system, alternatively, the beam relay/reflection device 300 may also include other components not shown, such as a memory, a radio frequency link, a baseband processing unit, a network interface, a controller, and the like. The processing circuit may be associated with a memory. For example, the processing circuit can be directly or indirectly connected to the memory (for example, other components may be connected therebetween) to access data. The memory can store various information acquired and generated by the processing circuit 302. The memory can also be located in the beam relay/reflection device but outside the processing circuit, or even outside the beam relay/reflection device. The memory may be a volatile memory and/or a nonvolatile memory. For example, the memory may include, but not limited to, random access memory (RAM), dynamic random-access memory (DRAM), static random-access memory (SRAM), read-only memory (ROM), and flash memory.

Hereinafter, a method of beam relaying in a wireless communication system according to an embodiment of the present disclosure will be described with reference to the drawings, and FIG. 3B shows a flowchart of a method 320 of beam relaying according to an embodiment of the present disclosure.

In the method 320, in step S321 (which can be called a receiving step), a beam emitted from a beam source in the non-terrestrial wireless communication network can be received, and in step S322 (which can be called a transmitting step), the received beam can be transmitted to a target object based on setting information of the target object, wherein the beam source is an aerial device capable of emitting beams in the non-terrestrial wireless communication network

In addition, the method may also include corresponding steps to realize the operations performed by the beam relay/reflection device described above. It should be noted that these steps can be performed by the aforementioned beam relay/reflection device according to the present disclosure, in particular by corresponding units of the aforementioned beam relay/reflection device according to the present disclosure.

A control-side electronic device in a wireless communication system according to an embodiment of the present disclosure will be described below. The control side can be a party in the wireless communication system that initiates downlink communication and/or receives uplink communication, and it can be appropriately selected according to the signal transmission direction in the wireless communication scene. In particular, for example, when downlink communication is performed from a base station to a user terminal, the control side can refer to the base station side. It should be noted that the control-side electronic device may correspond to a device in a wireless communication system communicating in a communication scenario (such as a base station in the communication system) itself, or be an electronic device used in combination with the device.

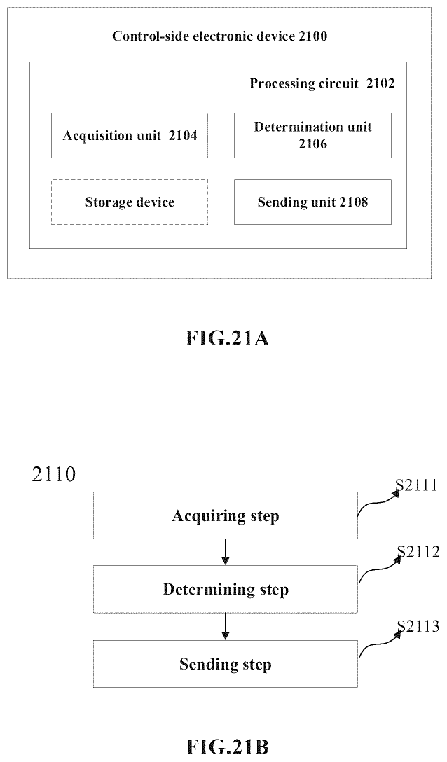

FIG. 21A shows a block diagram of a control-side electronic device according to an embodiment of the present disclosure. The control-side electronic device 2100 can communicate with other devices in the wireless communication system, such as a beam source, a beam relay/reflection device and even a terminal device in the system. In particular, compared with the control side, other devices communicating with the control-side electronic equipment can be referred to as access-side devices, that is, the beam source and the beam relay/reflection device can be referred to as access-side devices with respect to the control-side electronic device, which can be a party in the wireless communication system receiving downlink communication and/or initiating uplink communication with respect to the control-side electronic device.

An access-side electronic device 2100 includes a processing circuit 2102 configured to acquire setting information of a beam transmission target object in the non-terrestrial wireless communication network, determine a beam relay/reflection device that can be used to receive and transmit a beam from a beam source based on the setting information of the target object, wherein the beam source is an aerial device capable of emitting beams in the non-terrestrial wireless communication network, and send the setting information of the target object to the determined beam relay/reflection device, so that the beam relay/reflection device can transmit the received beam from the beam source to the target object.

In some embodiments, the processing circuit may be further configured to acquire the setting information of the beam source and control the beam relay/reflection device, so that the beam relay/reflection device can be configured based on the setting information of the beam source to receive the beam transmitted from the beam source.

In some embodiments, the processing circuit may be further configured to acquire setting information of the beam relay/reflection device and control the beam source, so that the beam source can be configured based on the setting information of the beam relay/reflection device to transmit a beam toward the beam relay/reflection device.

In some embodiments, the processing circuit may be further configured to send time information of beam transmission for the target object to the beam relay/reflection de vice, so that the beam relay/reflection device can transmit the received beam from the beam source to the target object within the time specified by the time information of beam transmission.

In some embodiments, the processing circuit may be further configured to predict the time information based on setting information of the beam source, the target object, and the beam relay/reflection device.

In some embodiments, the processing circuit may be further configured to, when an old beam source used for emitting beams is handed over to a new beam source, inform the new beam source of the setting information of the target object and the beam relay/reflection device corresponding to the target object, so that the new beam source can transmit beams to the beam relay/reflection device.

In some embodiments, the processing circuit may be further configured to, when an old beam source used for emitting beams is handed over to a new beam source, inform the old beam source of parameter information of the new beam source, so that the old beam source instructs the beam relay/reflection device to switch to the new beam source.

In some embodiments, the processing circuit may be further configured to, when an old beam source used for emitting beams is handed over to a new beam source, acquire setting information of the new beam source, and send the setting information of the new beam source to the beam relay/reflection device, so that the beam relay/reflection device can be configured based on the setting information of the new beam source to receive a beam from the new beam source.

In some embodiments, the processing circuit may be further configured to, in a scenario where the target object is mobile, divide the movement time of the target object into time slots; and for the target object in each time slot, determine a beam relay/reflection device suitable for the target object in that time slot, so that a beam can be transmitted to the target object in that time slot via the determined beam relay/reflection device.

In some embodiments, the processing circuit may be further configured to, in a scenario where the target object is a mobile terminal, perform beam measurement with the terminal to determine the beam direction of the terminal, and inform the beam relay/reflection device of the determined beam direction, so that the beam relay/reflection device can track the terminal based on the beam direction to transmit the beam.

It should be noted that the control-side electronic device 2100 can be implemented in various appropriate ways, especially in a manner similar to the beam relay/reflection device 300. For example, various units may be included to realize the aforementioned operations/functions, such as an acquisition unit 2104 configured to acquire setting information of a beam transmission target object in the non-terrestrial wireless communication network, a determination unit 2106 configured to determine a beam relay/reflection device that can be used to receive and transmit a beam from a beam source based on the setting information of the target object, wherein the beam source is an aerial device capable of emitting beams in the non-terrestrial wireless communication network, and a sending unit 2108 configured to send the setting information of the target object to the determined beam relay/reflection device, so that the beam relay/reflection device can transmit the received beam from the beam source to the target object. It should be pointed out that the above-mentioned acquisition unit, determination unit and sending unit can also perform various operations performed by the above-mentioned processing circuit, such as notifying or sending various information to various devices in the system, etc., which will not be described in detail here.

In some embodiments, the control-side electronic device 2100 may further include corresponding units for implementing the above operations, such as a unit for time slot division, a unit for beam measurement, etc., which will not be described in detail here.

It should be noted that the units of the control-side electronic device can also be implemented as described above for the device 300, such as implemented by software, firmware, hardware or any combination, which will not be described in detail here. In addition, the processing circuit 2102 may also include a memory, which may be located outside the processing circuit or even outside the control-side electronic device. The processing circuit may also include other components, which will not be described in detail here, as described above for the beam relay/reflection device.

Hereinafter, a method for a control side in a wireless communication system according to an embodiment of the present disclosure will be described with reference to the drawings, and FIG. 21B shows a flowchart of a method 2110 for a control-side in a wireless communication system according to an embodiment of the present disclosure. In step S2111 (which can be called an acquisition step), setting information of a beam transmission target object in the non-terrestrial wireless communication network can be acquired, in step S2112 (which can be called a determination step), a beam relay/reflection device that can be used to receive and transmit a beam from a beam source can be determined based on the setting information of the target object, wherein the beam source is an aerial device capable of emitting beams in the non-terrestrial wireless communication network, and in step S2113 (which can be called a sending step), the setting information of the target object can be sent to the determined beam relay/reflection device, so that the beam relay/reflection device can transmit the received beam from the beam source to the target object

In addition, the method may also include corresponding steps to implement the operations performed by the control-side electronic device as described above. It should be noted that these steps can be performed by the aforementioned control-side electronic device according to the present disclosure, in particular, by corresponding units of the aforementioned control-side electronic device according to the present disclosure.

It should be noted that the above description is only exemplary. The embodiments of the present disclosure can also be executed in any other appropriate way, and still can achieve the advantageous effects obtained by the embodiments according to the present disclosure. Furthermore, the embodiments of the present disclosure can also be applied to other similar application instances, and the advantageous effects obtained by embodiments of the present disclosure can still be achieved.

It should be understood that the machine-executable instructions in the machine-readable storage medium or program product according to the embodiments of the present disclosure may be configured to perform operations corresponding to the above-mentioned device and method embodiments. With reference to the above device and method embodiments, the embodiments of the machine-readable storage medium or program product are clear to those skilled in the art, and therefore will not be described repeatedly. Machine readable storage medium and program products for carrying or including the above-mentioned machine-executable instructions also fall within the scope of the present disclosure. Such a storage medium may include, but not limited to, a floppy disk, an optical disk, a magneto-optical disk, a storage card, a memory stick, and the like.

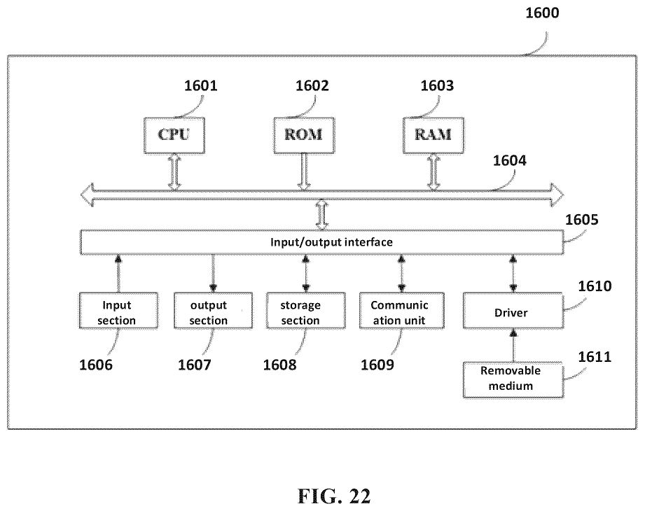

In addition, it should be understood that the processes and devices described above may also be implemented by software and/or firmware. When implemented by software and/or firmware, a program constituting the software can be installed from a storage medium or a network to a computer having a dedicated hardware structure, such as a general-purpose personal computer 1600 shown in FIG. 22, and the computer, when installing various programs thereon, can perform a variety of functions. FIG. 22 is a block diagram illustrating an example structure of a personal computer as an information processing apparatus that can be adopted in an embodiment of the present disclosure. In one example, the personal computer may correspond to the above-described exemplary beam relay/reflection device or control-side electronic device according to the present disclosure.

In FIG. 22, a central processing unit (CPU) 1601 performs various processes according to a program stored in a read only memory (ROM) 1602 or a program loaded from a storage section 1608 to a random-access memory (RAM) 1603. In the RAM 1603, data required when the CPU 1601 executes various processes and the like can be also stored as necessary.

The CPU 1601, the ROM 1602, and the RAM 1603 are connected to each other via a bus 1604. An input/output interface 1605 is also connected to the bus 1604.

The following components are connected to the input/output interface 1605: an input section 1606 including a keyboard, a mouse, etc. ; an output section 1607 including a display, such as a cathode ray tube (CRT), a liquid crystal display (LCD), etc., and a speaker, etc. ; a storage section 1608 including hard disks, etc. ; and a communication section 1609 including a network interface card such as LAN card, modem, etc. The communication section 1609 performs communication processing via a network such as the Internet.

A driver 1160 is also connected to the input/output interface 1605 as needed. A removable medium 1611 such as a magnetic disk, an optical disk, a magneto-optical disk, a semiconductor memory, etc. is installed on the drive 1160 as needed, so that a computer program read out therefrom can be installed into the storage section 1608 as needed.

In a case where the above-mentioned processes are realized by a software, the programs constituting the software are installed from a network such as the Internet or a storage medium such as a removable medium 1611.

Those skilled in the art should understand that such a storage medium is not limited to the removable medium 1611 shown in FIG. 22 in which the program is stored, and which is distributed separately from the device to provide the program to the user. Examples of the removable medium 1611 include a magnetic disk (including a floppy disk (registered trademark)), an optical disk (including a Compact disc read-only memory (CD-ROM) and a digital versatile disk (DVD)), and a magneto-optical disk (including a mini disk (MD) (registered trademark)) and semiconductor memory. Alternatively, the storage medium may be ROM 1602, a hard disk included in the storage section 1608, and the like, in which programs are stored and which are distributed to users along with the device containing them.

The technology of the present disclosure can be applied to various products.

For example, the control-side electronic devices according to embodiments of the present disclosure can be implemented as a variety of control devices/base stations, or be included therein. For example, the terminal device according to embodiments of the present disclosure can be implemented as a variety of terminal devices or be included in a variety of terminal devices.

For example, the control-side device/base station mentioned in the present disclosure can be implemented as any type of base station, for example, evolved Node B (eNB), such as macro eNB and small eNB. A small eNB may be an eNB covering a cell smaller than a macro cell, such as a pico eNB, a micro eNB, and a home (femto) eNB. Furthermore, for example, the terminal device/base station can be implemented as gNB, such as macro gNB and small gNB. A small gNB may be a gNB covering a cell smaller than a macro cell, such as a pico gNB, a micro gNB, and a home (femto) gNB. Alternatively, the base station can be implemented as any other type of base station, such as a NodeB and a Base Transceiver Station (BTS). The base station may include: a main body (also referred to as a base station device) configured to control wireless communication; and one or more remote radio heads (RRHs) disposed at a place different from the main body. In addition, various types of terminals described below can work as base stations by temporarily or semi-persistently performing base station functions.

For example, in some embodiments, the terminal device mentioned in the present disclosure can be implemented as a mobile terminal such as an intelligent phone, a tablet personal computer (PC), a notebook PC, a portable gaming terminal, a portable/dongle Mobile routers and digital cameras, or vehicle terminals such as vehicle navigation equipment. The terminal device can also be implemented as a terminal that performs machine-to-machine (M2M) communication, also called as a machine type communication (MTC) terminal. In addition, the terminal device may be a wireless communication module mounted on each of the terminals described above, such as an integrated circuit module including a single chip.

Examples according to the present disclosure will be described below with reference to the figures.

### Example of Base Station

It should be understood that the term “base station” in the present disclosure has the full breadth of its usual meaning and includes at least a wireless communication station that is used as part of a wireless communication system or radio system for communication. Examples of base stations may be, for example but not limited to, the following: maybe one or both of a base transceiver station (BTS) and a base station controller (BSC) in a GSM system, may be one or both of a radio network controller (RNC) and Node B in a WCDMA system, may be eNBs in LTE and LTE-Advanced systems, or may be corresponding network nodes in future communication systems (such as gNB, eLTE eNB, etc. that may appear in 5G communication systems). Part of the functions in the base station of the present disclosure can also be implemented as an entity with control function for communication in D2D, M2M, and V2V communication scenarios, or as an entity that plays a spectrum coordination role in cognitive radio communication scenarios.

### First Example

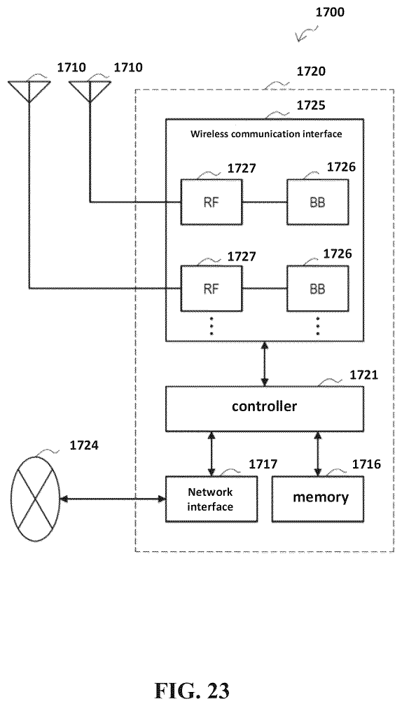

FIG. 23 is a block diagram illustrating a first example of a schematic configuration of a gNB to which the technology of the present disclosure can be applied. The gNB 1700 includes a plurality of antennas 1710 and a base station device 1720. The base station device 1720 and each antenna 1710 may be connected to each other via an RF cable. In an implementation manner, the gNB 1700 (or the base station device 1720) herein may correspond to the above-mentioned transmitting-side and/or receiving-side electronic device.

Each of the antennas 1710 includes a single or multiple antenna elements, such as multiple antenna elements included in a multiple-input multiple-output (MIMO) antenna, and is used for the base station device 1720 to transmit and receive wireless signals. As shown in FIG. 23, the gNB 1700 may include a plurality of antennas 1710. For example, multiple antennas 1710 may be compatible with multiple frequency bands used by gNB 1700.

The base station device 1720 includes a controller 1721, a memory 1722, a network interface 1717, and a wireless communication interface 1725.

The controller 1721 may be, for example, a CPU or a DSP, and operates various functions of the base station device 1720 at a higher layer. For example, the controller 1721 determines location information about a target terminal device in at least one terminal device on the terminal side of a wireless communication system based on the location information and specific position setting information about the at least one terminal device acquired via a wireless communication interface 1725. The controller 1721 may have logical functions that perform controls such as radio resource control, radio bearer control, mobility management, admission control, and scheduling. The controls can be performed in conjunction with a nearby gNB or core network node. The memory 1722 includes a RAM and a ROM, and stores a program executed by the controller 1721 and various types of control data such as a terminal list, transmission power data, and scheduling data.

The network interface 1717 is a communication interface for connecting the base station device 1720 to the core network 1724. The controller 1721 may communicate with a core network node or another gNB via the network interface 1717. In this case, the gNB 1700 and the core network node or other gNBs may be connected to each other through a logical interface such as an S1 interface and an X2 interface. The network interface 1717 may also be a wired communication interface or a wireless communication interface for a wireless backhaul line. If the network interface 1717 is a wireless communication interface, compared with the frequency band used by the wireless communication interface 1725, the network interface 1717 can use a higher frequency band for wireless communication.

The wireless communication interface 1725 supports any cellular communication scheme such as Long-Term Evolution (LTE) and LTE-Advanced, and provides a wireless connection to a terminal located in a cell of the gNB 1700 via an antenna 1710. The wireless communication interface 1725 may generally include, for example, a baseband (BB) processor 1726 and an RF circuit 1727. The BB processor 1726 may perform, for example, encoding/decoding, modulation/demodulation, and multiplexing/demultiplexing, and execute various types of signal processing in layers such as L1, Medium Access Control (MAC), Radio Link Control (RLC), and Group Data Convergence Protocol (PDCP). As an alternative of the controller 1721, the BB processor 1726 may have a part or all of the above-mentioned logical functions. The BB processor 1726 may be a memory storing a communication control program, or a module including a processor and related circuits configured to execute the program. Updating the program can change the function of the BB processor 1726. The module may be a card or a blade inserted into a slot of the base station device 1720. Alternatively, the module may be a chip mounted on a card or a blade. Meanwhile, the RF circuit 1727 may include, for example, a mixer, a filter, and an amplifier, and transmits and receives a wireless signal via the antenna 1710. Although FIG. 23 illustrates an example in which one RF circuit 1727 is connected to one antenna 1710, the present disclosure is not limited to this illustration, but one RF circuit 1727 may be connected to multiple antennas 1710 at the same time.

As shown in FIG. 23, the wireless communication interface 1725 may include a plurality of BB processors 1726. For example, the plurality of BB processors 1726 may be compatible with multiple frequency bands used by gNB 1700. As shown in FIG. 23, the wireless communication interface 1725 may include a plurality of RF circuits 1727. For example, the plurality of RF circuits 1727 may be compatible with multiple antenna elements. Although FIG. 23 illustrates an example in which the wireless communication interface 1725 includes a plurality of BB processors 1726 and a plurality of RF circuits 1727, the wireless communication interface 1725 may also include a single BB processor 1726 or a single RF circuit 1727.

### Second Example

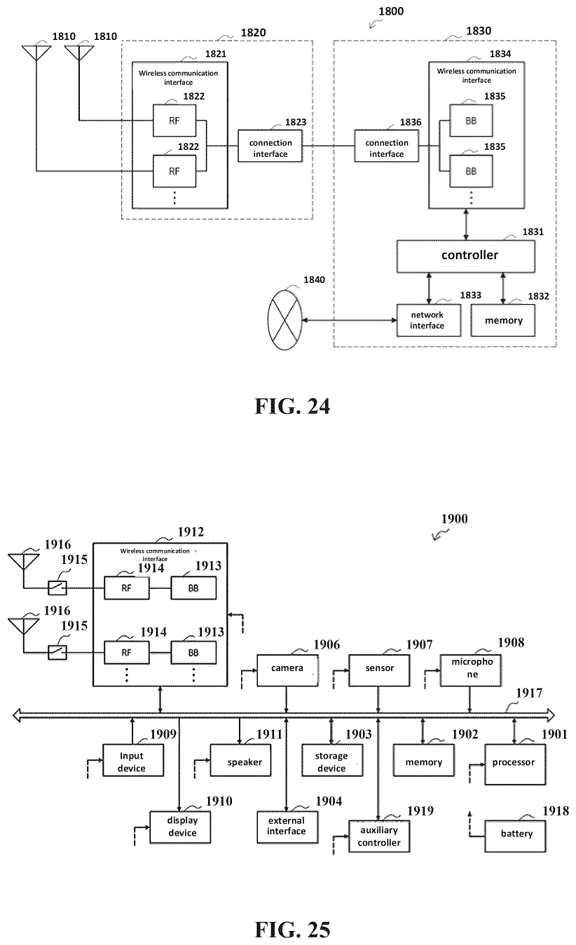

FIG. 24 is a block diagram illustrating a second example of a schematic configuration of a gNB to which the technology of the present disclosure can be applied. The gNB 1800 includes multiple antennas 1810, RRH 1820 and base station equipment 1830. The RRH 1820 and each antenna 1810 may be connected to each other via an RF cable. The base station equipment 1830 and the RRH 1820 may be connected to each other via a high-speed line such as a fiber optic cable. In an implementation manner, the gNB 1800 (or the base station equipment 1830) herein may correspond to the foregoing transmitting-side and/or receiving-side electronic device.

Each of the antennas 1810 includes a single or multiple antenna elements (such as multiple antenna elements included in a MIMO antenna) and is used for RRH 1820 to transmit and receive wireless signals. As shown in FIG. 24, the gNB 1800 may include multiple antennas 1810. For example, multiple antennas 1810 may be compatible with multiple frequency bands used by gNB 1800.

The base station device 1830 includes a controller 1831, a memory 1832, a network interface 1833, a wireless communication interface 1834, and a connection interface 1836. The controller 1831, the memory 1832, and the network interface 1833 are the same as the controller 1721, the memory 1722, and the network interface 1717 described with reference to FIG. 23.

The wireless communication interface 1834 supports any cellular communication scheme such as LTE and LTE-Advanced, and provides wireless communication to a terminal located in a sector corresponding to the RRH 1820 via the RRH 1820 and the antenna 1810. The wireless communication interface 1834 may typically include, for example, a BB processor 1835. The BB processor 1835 is the same as the BB processor 1726 described with reference to FIG. 23 except that the BB processor 1835 is connected to the RF circuit 1822 of the RRH 1820 via the connection interface 1836. As shown in FIG. 24, the wireless communication interface 1834 may include a plurality of BB processors 1835. For example, multiple BB processors 1835 may be compatible with multiple frequency bands used by gNB 1800. Although FIG. 24 illustrates an example in which the wireless communication interface 1834 includes a plurality of BB processors 1835, the wireless communication interface 1834 may also include a single BB processor 1835.

The connection interface 1836 is an interface for connecting the base station device 1830 (wireless communication interface 1834) to the RRH 1820. The connection interface 1836 may also be a communication module for communication in the above-mentioned high-speed line connecting the base station device 1830 (wireless communication interface 1834) to the RRH 1820.

The RRH 1820 includes a connection interface 1823 and a wireless communication interface 1821.

The connection interface 1823 is an interface for connecting the RRH 1820 (wireless communication interface 1821) to the base station device 1830. The connection interface 1823 may also be a communication module for communication in the above-mentioned high-speed line.

The wireless communication interface 1821 transmits and receives wireless signals via the antenna 1810. The wireless communication interface 1821 may generally include, for example, an RF circuit 1822. The RF circuit 1822 may include, for example, a mixer, a filter, and an amplifier, and transmits and receives wireless signals via the antenna 1810. Although FIG. 24 illustrates an example in which one RF circuit 1822 is connected to one antenna 1810, the present disclosure is not limited to this illustration, but one RF circuit 1822 may be connected to multiple antennas 1810 at the same time.

As shown in FIG. 24, the wireless communication interface 1821 may include a plurality of RF circuits 1822. For example, the plurality of RF circuits 1822 may support multiple antenna elements. Although FIG. 24 illustrates an example in which the wireless communication interface 1821 includes a plurality of RF circuits 1822, the wireless communication interface 1821 may include a single RF circuit 1822.

### Example of User Device/Terminal Device

### First Example

FIG. 25 is a block diagram illustrating an example of a schematic configuration of a communication device 1900, such as smart phone, linker, etc., to which the technology of the present disclosure can be applied. The communication device 1900 includes a processor 1901, a memory 1902, a storage device 1903, an external connection interface 1904, a camera device 1906, a sensor 1907, a microphone 1908, an input device 1909, a display device 1910, a speaker 1911, a wireless communication interface 1912, one or more antenna switches 1915, one or more antennas 1916, a bus 1917, a battery 1918, and an auxiliary controller 1919. In an implementation manner, the communication device 1900 (or the processor 1901) herein may correspond to the foregoing transmitting device or terminal-side electronic device.

The processor 1901 may be, for example, a CPU or a system on chip (SoC), and controls functions of an application layer and another layer of the smart phone 1900. The memory 1902 includes a RAM and a ROM, and stores data and programs executed by the processor 1901. The storage device 1903 may include a storage medium such as a semiconductor memory and a hard disk. The external connection interface 1904 is an interface for connecting external devices such as a memory card and a universal serial bus (USB) device to the smart phone 1900.

The camera device 1906 includes an image sensor such as a charge-coupled device (CCD) and a complementary metal oxide semiconductor (CMOS), and generates a captured image. The sensor 1907 may include a set of sensors such as a measurement sensor, a gyroscope sensor, a geomagnetic sensor, and an acceleration sensor. The microphone 1908 converts a sound input to the smart phone 1900 into an audio signal. The input device 1909 includes, for example, a touch sensor, a keypad, a keyboard, a button, or a switch configured to detect a touch on the screen of the display device 1910, and receives an operation or information input from a user. The display device 1910 includes a screen such as a liquid crystal display (LCD) and an organic light emitting diode (OLED) display, and displays an output image of the smart phone 1900. The speaker 1911 converts an audio signal output from the smart phone 1900 into a sound.

The wireless communication interface 1912 supports any cellular communication scheme such as LTE and LTE-Advanced, and performs wireless communication. The wireless communication interface 1912 may generally include, for example, a BB processor 1913 and an RF circuit 1914. The BB processor 1913 may perform, for example, encoding/decoding, modulation/demodulation, and multiplexing/demultiplexing, and perform various types of signal processing for wireless communication. Meanwhile, the RF circuit 1914 may include, for example, a mixer, a filter, and an amplifier, and transmits and receives wireless signals via the antenna 1916. The wireless communication interface 1912 may be a chip module on which a BB processor 1913 and an RF circuit 1914 are integrated. As shown in FIG. 25, the wireless communication interface 1912 may include multiple BB processors 1913 and multiple RF circuits 1914. Although FIG. 25 illustrates an example in which the wireless communication interface 1912 includes a plurality of BB processors 1913 and a plurality of RF circuits 1914, the wireless communication interface 1912 may also include a single BB processor 1913 or a single RF circuit 1914.

In addition, in addition to the cellular communication scheme, the wireless communication interface 1912 may support other types of wireless communication scheme, such as a short-range wireless communication scheme, a near field communication scheme, and a wireless local area network (LAN) scheme. In this case, the wireless communication interface 1912 may include a BB processor 1913 and an RF circuit 1914 for each wireless communication scheme.

Each of the antenna switches 1915 switches a connection destination of the antenna 1916 between a plurality of circuits included in the wireless communication interface 1912 (for example, circuits for different wireless communication schemes).

Each of the antennas 1916 includes a single or multiple antenna elements, such as multiple antenna elements included in a MIMO antenna, and is used for the wireless communication interface 1912 to transmit and receive wireless signals. As shown in FIG. 25, the smart phone 1900 may include a plurality of antennas 1916. Although FIG. 25 illustrates an example in which the intelligent phone 1900 includes a plurality of antennas 1916, the intelligent phone 1900 may also include a single antenna 1916.

In addition, the smart phone 1900 may include an antenna 1916 for each wireless communication scheme. In this case, the antenna switches 1915 may be omitted from the configuration of the smart phone 1900.

The bus 1917 connects the processor 1901, the memory 1902, the storage device 1903, the external connection interface 1904, the camera device 1906, the sensor 1907, the microphone 1908, the input device 1909, the display device 1910, the speaker 1911, the wireless communication interface 1912, and the auxiliary controller 1919 to each other. The battery 1918 supplies power to each block of the smart phone 1900 shown in FIG. 25 via a feeder, and the feeder is partially shown as a dotted line in the figure. The auxiliary controller 1919 operates the minimum necessary functions of the smart phone 1900 in the sleep mode, for example.

### Second Example

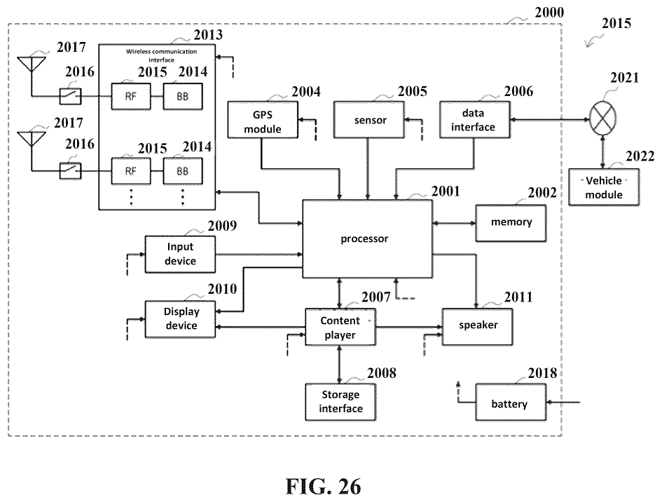

FIG. 26 is a block diagram illustrating an example of a schematic configuration of a vehicle navigation device 2000 to which the technology of the present disclosure can be applied. The vehicle navigation device 2000 includes a processor 2001, a memory 2002, a global location system (GPS) module 2004, a sensor 2005, a data interface 2006, a content player 2007, a storage medium interface 2008, an input device 2009, a display device 2010, a speaker 2011, and a wireless communication interface 2013, one or more antenna switches 2016, one or more antennas 2017, and a battery 2018. In an implementation manner, the vehicle navigation device 2000 (or the processor 2001) herein may correspond to the transmitting device or terminal-side electronic device.

The processor 2001 may be, for example, a CPU or a SoC, and controls navigation functions and other functions of the vehicle navigation device 2000. The memory 2002 includes a RAM and a ROM, and stores data and programs executed by the processor 2001.

The GPS module 2004 uses a GPS signal received from a GPS satellite to measure the position (such as latitude, longitude, and altitude) of the vehicle navigation device 2000. The sensor 2005 may include a set of sensors such as a gyroscope sensor, a geomagnetic sensor, and an air pressure sensor. The data interface 2006 is connected to, for example, an in-vehicle network 2021 via a terminal not shown, and acquires data (such as vehicle speed data) generated by the vehicle.

The content player 2007 reproduces content stored in a storage medium such as a CD and a DVD, which is inserted into the storage medium interface 2008. The input device 2009 includes, for example, a touch sensor, a button, or a switch configured to detect a touch on the screen of the display device 2010, and receives an operation or information input from a user. The display device 2010 includes a screen such as an LCD or OLED display, and displays an image of a navigation function or reproduced content. The speaker 2011 outputs the sound of the navigation function or the reproduced content.

The wireless communication interface 2013 supports any cellular communication scheme such as LTE and LTE-Advanced, and performs wireless communication. The wireless communication interface 2013 may generally include, for example, a BB processor 2014 and an RF circuit 2015. The BB processor 2014 may perform, for example, encoding/decoding, modulation/demodulation, and multiplexing/demultiplexing, and perform various types of signal processing for wireless communication. Meanwhile, the RF circuit 2015 may include, for example, a mixer, a filter, and an amplifier, and transmit and receive wireless signals via the antenna 2017. The wireless communication interface 2013 may also be a chip module on which a BB processor 2014 and an RF circuit 2015 are integrated. As shown in FIG. 26, the wireless communication interface 2013 may include a plurality of BB processors 2014 and a plurality of RF circuits 2015. Although FIG. 26 illustrates an example in which the wireless communication interface 2013 includes a plurality of BB processors 2014 and a plurality of RF circuits 2015, the wireless communication interface 2013 may also include a single BB processor 2014 or a single RF circuit 2015.

In addition, in addition to the cellular communication scheme, the wireless communication interface 2013 may support other types of wireless communication scheme, such as a short-range wireless communication scheme, a near field communication scheme, and a wireless LAN scheme. In this case, the wireless communication interface 2013 may include a BB processor 2014 and an RF circuit 2015 for each wireless communication scheme.

Each of the antenna switches 2016 switches the connection destination of the antenna 2017 between a plurality of circuits included in the wireless communication interface 2013, such as circuits for different wireless communication schemes.

Each of the antennas 2017 includes a single or multiple antenna element, such as multiple antenna elements included in a MIMO antenna, and is used for the wireless communication interface 2013 to transmit and receive wireless signals. As shown in FIG. 26, the vehicle navigation device 2000 may include a plurality of antennas 2017. Although FIG. 26 illustrates an example in which the vehicle navigation device 2000 includes a plurality of antennas 2017, the vehicle navigation device 2000 may also include a single antenna 2017.

In addition, the vehicle navigation device 2000 may include an antenna 2017 for each wireless communication scheme. In this case, the antenna switches 2016 may be omitted from the configuration of the vehicle navigation device 2000.

The battery 2018 supplies power to each block of the vehicle navigation device 2000 shown in FIG. 26 via a feeder, and the feeder is partially shown as a dotted line in the figure. The battery 2018 accumulates power provided from the vehicle.

The technology of the present disclosure may also be implemented as a vehicle on board system (or vehicle) 2020 including one or more of a vehicle navigation device 2000, an in-vehicle network 2021, and a vehicle module 2022. The vehicle module 2022 generates vehicle data such as vehicle speed, engine speed, and failure information, and outputs the generated data to the in-vehicle network 2021.

The exemplary embodiments of the present disclosure have been described above with reference to the drawings, but the present disclosure is of course not limited to the above examples. Those skilled in the art may find various alternations and modifications within the scope of the appended claims, and it should be understood that they will naturally fall in the technical scope of the present disclosure.

It should be understood that the machine-executable instructions in the machine-readable storage medium or program product according to the embodiments of the present disclosure may be configured to perform operations corresponding to the above-mentioned device and method embodiments. When referring to the above device and method embodiments, the embodiments of the machine-readable storage medium or program product are clear to those skilled in the art, and therefore will not be described repeatedly. Machine-readable storage medium and program products for carrying or including the above-mentioned machine-executable instructions also fall within the scope of the present disclosure. Such a storage medium may include, but is not limited to, a floppy disk, an optical disk, a magneto-optical disk, a memory card, a memory stick, and the like.

In addition, it should be understood that the processes and devices described above may also be implemented by software and/or firmware. In the case of implementation by software and/or firmware, corresponding programs constituting the corresponding software are stored in the storage medium of the related device, and the programs, when executed, can perform various functions.

For example, a plurality of functions included in one unit in the above embodiment can be realized by separate devices. Alternatively, a plurality of functions implemented by multiple units in the above embodiments may be respectively realized by separate devices. In addition, one of the above functions can be realized by multiple units, and of course, such a configuration also falls in the technical scope of the present disclosure.

In the description, the steps described in the flowchart include not only the processes that are executed in the stated order in time sequence, but also the processes that are executed in parallel or solely instead of necessarily in time sequence. In addition, even in the step of processing in time sequence, needless to say, the order can be appropriately changed.

In addition, the method and system of the present disclosure can be implemented in various ways. For example, the methods and systems of the present disclosure may be implemented by software, hardware, firmware, or any combination thereof. The order of the steps of the method described above is only illustrative, and the steps of the method of the present disclosure are not limited to the order specifically described above unless otherwise specified. Furthermore, in some embodiments, the present disclosure can also be embodied as a program recorded in a recording medium, including machine-readable instructions for implementing the method according to the present disclosure. Therefore, the present disclosure also covers a recording medium storing a program for implementing the method according to the present disclosure. Such storage media may include, but not limited to, floppy disks, optical disks, magneto-optical disks, memory cards, memory sticks, and the like.

Those skilled in the art should realize that the boundaries between the above operations are merely illustrative. Multiple operations can be combined into a single operation, the single operation can be distributed among additional operations, and the operations can be performed at least partially overlapping in time. Moreover, alternative embodiments may include multiple instances of specific operations, and the order of operations may be changed in other various embodiments. However, other modifications, variations and substitutions are also possible. Therefore, the specification and drawings should be regarded as illustrative rather than restrictive.

In addition, the embodiments of the present disclosure may also include the following exemplary embodiments (EE).
EE1. A beam relay/reflection device in a non-terrestrial wireless communication network, the beam relay/reflection device comprising a processing circuit configured to:
receive a beam emitted from a beam source in the non-terrestrial wireless communication network, and
transmit the received beam to a target object based on setting information of the target object,
wherein, the beam source is an aerial device capable of emitting beams in the non-terrestrial wireless communication network.
EE2. The beam relay/reflection device according to EE1, wherein the target object includes a target area to be beam-covered, and the setting information of the target area includes geographical location information and size information of the target area.
EE3. The beam relay/reflection device according to EE2, wherein the target area includes at least one sub-area, and for each sub-area, a control-side device in the non-terrestrial wireless communication network sets at least one beam relay/reflection device based on the setting information of the sub-area.
EE4. The beam relay/reflection device according to EE1, wherein the target object includes a terminal device to be beam-covered, and the setting information of the terminal device includes at least one of geographical location information of the terminal device and a beam direction of the terminal device.
EE5. The beam relay/reflection device according to EE4, wherein the beam direction of the terminal device is acquired by a control-side device through beam measurement with the terminal device.
EE6. The beam relay/reflection device according to EE1, wherein the processing circuit is further configured to:
acquire time information of beam transmission to the target object, and
perform beam transmission at a time specified by the time information of the beam transmission.
EE7. The beam relay/reflection device according to EE6, wherein the time information includes a start time and an end time, and performing beam transmission at the time specified by the time information of the beam transmission includes starting the beam transmission to the target object at the start time, and stopping the beam transmission to the target object at the end time.
EE8. The beam relay/reflection device according to EE1, wherein the processing circuit is further configured to:
acquire setting information of the beam source,
set the beam relay/reflection device based on the setting information of the beam source to receive the beam from the beam source.
EE9. The beam relay/reflection device according to EE8, wherein the setting information of the beam source includes at least one of spatial location information and a beam emission parameter of the beam source.
EE10. The beam relay/reflection device according to EE9, wherein the spatial position information of the beam source includes at least one of a geographic location of the beam source and a spatial motion trajectory of the beam source; and/or
the beam emission parameter includes at least one of a beam direction of the beam source and an antenna radiation pattern of the beam source.
EE11. The beam relay/reflection device according to EE8, wherein acquiring the setting information of the beam source includes periodically acquiring the setting information of the beam source from a control-side device in the non-terrestrial wireless communication network, or sending a request to a control-side device in the non-terrestrial wireless communication network and acquiring the setting information of the beam source provided by the control-side device as a response.
EE12. The beam relay/reflection device according to EE1, wherein the processing circuit is further configured to:
inform a control-side device in the non-terrestrial wireless communication network of the setting information of the beam relay/reflection device, wherein
the beam source sets beam emission based on the setting information of the beam relay/reflection device to perform the beam emission to the beam relay/reflection device.
EE13. The beam relay/reflection device according to EE1 or EE12, wherein the setting information of the beam relay/reflection device includes orientation information of the beam relay/reflection device, and/or
the setting information of the beam relay/reflection device includes at least one of identification information and operation parameter information of the beam relay/reflection device.
EE14. The beam relay/reflection device according to EE13, wherein the orientation information includes at least one of an altitude, an orientation, and a geographic location of the beam relay/reflection device, and/or
wherein, the operation parameter information includes an operation time, an operation parameter of the beam relay/reflection device.
EE15. The beam relay/reflection device according to any one of EEs1-14, wherein during a time period in which the beam relay/reflection device receives the beam from the beam source and transmits it to the target object, the beam relay/reflection device acquires the setting information of the beam source at a specific time interval or acquires the setting information of the beam source as a response, and/or the beam relay/reflection device informs the beam source of the setting information of the beam relay/reflection device at a specific time interval or on demand.
EE16. The beam relay/reflection device according to EE1, wherein the beam source can perform beam emission based on control of a control-side device in the non-terrestrial wireless communication network.
EE17. The beam relay/reflection device according to EE1, wherein the beam source is integrated with a control-side device in the non-terrestrial wireless communication network, or the beam source is separated from the control-side device in the non-terrestrial wireless communication network.
EE18. The beam relay/reflection device according to EE1, wherein when the beam source is integrated with a control-side device of the non-terrestrial wireless communication network and the beam source is handed over, the processing circuit is further configured to:
acquire an indication from the control-side device of handing over to a new beam source,
receive a beam from the new beam source, and
transmit the received beam from the new beam source to the target object.
EE19. The beam relay/reflection device according to EE1, wherein when the beam source is separate from a control-side device of the non-terrestrial wireless communication network and the beam source is handed over, the processing circuit is further configured to:
acquire setting information from a new beam source,
set the beam relay/reflection device based on the setting information of the new beam source to receive a beam from the new beam source.
EE20. The beam relay/reflection device according to EE1, wherein when the target object includes a mobile target area, the target area is an area corresponding to a specific time slot within a movement time interval.
EE21. The beam relay/reflection device according to EE1, wherein the movement time interval is continuously divided from a movement time of the target area.
EE22. The beam relay/reflection device according to EE1, wherein the setting information of the beam relay/reflection device is able to be registered in the non-terrestrial wireless communication network in advance or during a communication operation.
EE23. A control-side device in a non-terrestrial wireless communication network, the control-side device comprising a processing circuit configured to:
acquire setting information of a beam transmission target object in the non-terrestrial wireless communication network,
determine a beam relay/reflection device capable of receiving and transmitting a beam from a beam source based on the setting information of the target object, wherein the beam source is an aerial device capable of emitting beams in the non-terrestrial wireless communication network, and
send the setting information of the target object to the determined beam relay/reflection device, so that the beam relay/reflection device is able to transmit the received beam from the beam source to the target object.
EE24. The control-side device according to EE23, wherein the processing circuit is further configured to:
acquire setting information of the beam source,
control the beam relay/reflection device, so that the beam relay/reflection device is set based on the setting information of the beam source to receive the beam emitted from the beam source.
EE25. The control-side device according to EE23, wherein the processing circuit is further configured to:
acquire setting information of the beam relay/reflection device, and
control the beam source, so that the beam source is set based on setting information of the beam relay/reflection device to perform beam emission to the beam relay/reflection device.
EE26. The control-side device according to EE23, wherein the processing circuit is further configured to:
send time information of beam transmission to the target object to the beam relay/reflection device, so that the beam relay/reflection device transmits the received beam from the beam source to the target object at a time specified by the time information of the beam transmission.
EE27. The control-side device according to EE23, wherein the processing circuit is further configured to:
predict the time information based on the setting information of the beam source, the target object, and the beam relay/reflection device.
EE28. The control-side device according to EE23, wherein the processing circuit is further configured to: when an old beam source for beam emission is handed over to a new beam source,
inform the new beam source of setting information of the target object and a beam relay/reflection device corresponding to the target object, so that the new beam source emits a beam to the beam relay and/or reflection device.
EE29. The control-side device according to EE23, wherein the processing circuit is further configured to: when an old beam source for beam emission is handed over to a new beam source,
inform the old beam source of parameter information of the new beam source, so that the old beam source instructs the beam relay/reflection device to switch to the new beam source.
EE30. The control-side device according to EE23, wherein the processing circuit is further configured to: when an old beam source for beam emission is handed over to a new beam source,
acquire setting information of a new beam source,
send the setting information of the new beam source to the beam relay/reflection device, so that the beam relay/reflection device is configured based on the setting information of the new beam source to receive a beam from the new beam source.
EE31. The control-side device according to EE23, wherein the processing circuit is further configured to: when the target object moves,
divide a target object movement time into time slots; and
for a target object in each time slot, determine a beam relay/reflection device suitable for the target object in the time slot, so that the beam is transmitted to the target object in the time slot via the determined beam relay/reflection device.
EE32. The control-side device according to EE31, wherein the processing circuit is further configured to:
determine coverage overlapping areas in different time slots based on the setting information of a current beam source and an adjacent beam source, and
determine a beam relay/reflection device to transmit beams from the beam source to the target object, based on overlapping area coverage requirements of different time slots.
EE33. The control-side device according to EE32, wherein the processing circuit is further configured to:
acquire ephemeris information of a current beam source and an adjacent beam source as the setting information.
EE34. The control-side device according to EE23, wherein when the target object is a mobile terminal, the processing circuit is further configured to:
perform beam measurement with the terminal to determine a beam direction of the terminal,
inform the beam relay/reflection device of the determined beam direction, so that the beam relay/reflection device tracks the terminal based on the beam direction to transmit the beam.
EE35. A beam relay method for a wireless communication system, the method comprising:
receiving a beam emitted from a beam source in the non-terrestrial wireless communication network, and
transmitting the received beam to a target object based on setting information of the target object,
wherein, the beam source is an aerial device capable of emitting beams in the non-terrestrial wireless communication network.
EE36. A method for a control side in a wireless communication system, the method comprising:
acquiring setting information of a beam transmission target object in the non-terrestrial wireless communication network,
determining a beam relay/reflection device capable of receiving and transmitting a beam from a beam source based on the setting information of the target object, wherein the beam source is an aerial device capable of emitting beams in the non-terrestrial wireless communication network, and
sending the setting information of the target object to the determined beam relay/reflection device, so that the beam relay/reflection device is able to transmit the received beam from the beam source to the target object.
EE37. A device, comprising:
at least one processor; and
at least one storage device storing instructions thereon, wherein the instructions, when executed by the at least one processor, cause the at least one processor to implement the method of EE35 or 36.
EE38. A storage medium, storing instructions which, when executed by a processor, cause implementation of the method of EE35 or 36.
EE39. A computer program product comprising instructions which, when executed by a processor, cause implementation of the method of EE35 or 36.
EE40. A computer program comprising instructions which, when executed by an electronic device, cause implementation of the method of EE35 or 36.

Although the present disclosure and its advantages have been described in detail, it should be understood that various changes, substitutions and alterations can be made hereto without departing from the spirit and scope of the present disclosure as defined by the appended claims. Furthermore, the terms “including”, “comprising”, or any other variation thereof, of the embodiments of the present disclosure are intended to encompass non-exclusive inclusion, such that a process, method, article, or device that includes a series of elements includes not only those elements, but also includes other elements not explicitly listed, or those inherent in the process, method, article, or equipment. Without more restrictions, the elements defined by the sentence “including a . . . ” do not exclude the existence of other identical elements in the process, method, article, or equipment including the elements.

Although some specific embodiments of the present disclosure have been described in detail, those skilled in the art should understand that the above-described embodiments are merely illustrative and do not limit the scope of the present disclosure. Those skilled in the art should understand that the above-described embodiments may be combined, modified, or replaced without departing from the scope and essence of the present disclosure. The scope of the present disclosure is defined by the appended claims.

1. A beam relay device in a non-terrestrial wireless communication network, the beam relay device comprising a processing circuit configured to:
receive a beam emitted from a beam source in the non-terrestrial wireless communication network, wherein the beam relay/reflection device is set based on the setting information of the beam source to receive the beam from the beam source, and
transmit the received beam to a target object based on setting information of the target object,
wherein, the beam source is an aerial device capable of emitting beams in the non-terrestrial wireless communication network.

2. The beam relay device according to claim 1, wherein the target object comprises a target area to be beam-covered, and the setting information of the target area comprises geographical location information and size information of the target area, or
wherein the target object comprises a terminal device to be beam-covered, and the setting information of the terminal device comprises at least one of geographical location information of the terminal device and a beam direction of the terminal device.

3.-5. (canceled)

6. The beam relay device according to claim 1, wherein the processing circuit is further configured to:
acquire time information of beam transmission to the target object, and
perform beam transmission at a time specified by the time information of the beam transmission,
wherein the time information comprises a start time and an end time, and performing beam transmission at the time specified by the time information of the beam transmission comprises starting the beam transmission to the target object at the start time, and stopping the beam transmission to the target object at the end time.

7.-8. (canceled)

9. The beam relay device according to claim 1, wherein the setting information of the beam source comprises at least one of spatial location information and a beam emission parameter of the beam source,
wherein the spatial position information of the beam source comprises at least one of a geographic location of the beam source and a spatial motion trajectory of the beam source; or
the beam emission parameter comprises at least one of a beam direction of the beam source and an antenna radiation pattern of the beam source.

10. (canceled)

11. The beam relay device according to claim 1, wherein the processing circuit is further configured to:
acquire setting information of the beam source,
wherein the acquiring the setting information of the beam source comprises periodically acquiring the setting information of the beam source from a control-side device in the non-terrestrial wireless communication network, or sending a request to a control-side device in the non-terrestrial wireless communication network and acquiring the setting information of the beam source provided by the control-side device as a response.

12. The beam relay device according to any one of claim 1, wherein the processing circuit is further configured to:
inform a control-side device in the non-terrestrial wireless communication network of the setting information of the beam relay device,
wherein the beam source sets beam emission based on the setting information of the beam relay device to perform the beam emission to the beam relay device,
wherein the setting information of the beam relay device comprises orientation information of the beam relay device, wherein the orientation information comprises at least one of an altitude, an orientation, and a geographic location of the beam relay device, or
wherein the setting information of the beam relay device comprises at least one of identification information and operation parameter information of the beam relay device, wherein the operation parameter information comprises an operation time, an operation parameter of the beam relay device.

13.-14. (canceled)

15. The beam relay device according to claim 1, wherein during a time period in which the beam relay device receives the beam from the beam source and transmits it to the target object, the beam relay device acquires the setting information of the beam source at a specific time interval or acquires the setting information of the beam source as a response, or the beam relay device informs the beam source of the setting information of the beam relay device at a specific time interval or on demand.

16.-17. (canceled)

18. The beam relay device according to claim 1, wherein when the beam source is integrated with a control-side device of the non-terrestrial wireless communication network and the beam source is handed over, the processing circuit is further configured to:
acquire an indication from the control-side device of handing over to a new beam source,
receive a beam from the new beam source, and
transmit the received beam from the new beam source to the target object, or
wherein when the beam source is separate from a control-side device of the non-terrestrial wireless communication network and the beam source is handed over, the processing circuit is further configured to:
acquire setting information from a new beam source,
set the beam relay device based on the setting information of the new beam source to receive a beam from the new beam source.

19. (canceled)

20. The beam relay device according to claim 1, wherein when the target object comprises a mobile target area, the target area is an area corresponding to a specific time slot within a movement time interval,
wherein the movement time interval is continuously divided from a movement time of the target area.

21. (canceled)

22. The beam relay device according to claim 1, wherein the setting information of the beam relay device is able to be registered in the non-terrestrial wireless communication network in advance or during a communication operation.

23. A control-side device in a non-terrestrial wireless communication network, the control-side device comprising a processing circuit configured to:
acquire setting information of a beam transmission target object in the non-terrestrial wireless communication network,
determine a beam relay/reflection device capable of receiving and transmitting a beam from a beam source based on the setting information of the target object, wherein the beam source is an aerial device capable of emitting beams in the non-terrestrial wireless communication network, and
send the setting information of the target object to the determined beam relay/reflection device, so that the beam relay/reflection device is able to transmit the received beam from the beam source to the target object.

24. The control-side device according to claim 23, wherein the processing circuit is further configured to:
acquire setting information of the beam source,
control the beam relay/reflection device, so that the beam relay/reflection device is set based on the setting information of the beam source to receive the beam emitted from the beam source.

25. The control-side device according to claim 23, wherein the processing circuit is further configured to:
acquire setting information of the beam relay/reflection device, and
control the beam source, so that the beam source is set based on setting information of the beam relay/reflection device to perform beam emission to the beam relay/reflection device.

26. The control-side device according to claim 23, wherein the processing circuit is further configured to:
send time information of beam transmission to the target object to the beam relay/reflection device, so that the beam relay/reflection device transmits the received beam from the beam source to the target object at a time specified by the time information of the beam transmission, wherein the time information is predicted based on the setting information of the beam source, the target object, and the beam relay/reflection device.

27. (canceled)

28. The control-side device according to claim 23, wherein the processing circuit is further configured to: when an old beam source for beam emission is handed over to a new beam source,
inform the new beam source of setting information of the target object and a beam relay/reflection device corresponding to the target object, so that the new beam source emits a beam to the beam relay and/or reflection device, or
inform the old beam source of parameter information of the new beam source, so that the old beam source instructs the beam relay/reflection device to switch to the new beam source, or
acquire setting information of a new beam source,
send the setting information of the new beam source to the beam relay/reflection device, so that the beam relay/reflection device is configured based on the setting information of the new beam source to receive a beam from the new beam source.

29.-30. (canceled)

31. The control-side device according to claim 23, wherein the processing circuit is further configured to: when the target object moves,
divide a target object movement time into time slots; and
for a target object in each time slot, determine a beam relay/reflection device suitable for the target object in the time slot, so that the beam is transmitted to the target object in the time slot via the determined beam relay/reflection device.

32. The control-side device according to claim 23, wherein the processing circuit is further configured to:
determine coverage overlapping areas in different time slots based on the setting information of a current beam source and an adjacent beam source, and
determine a beam relay/reflection device to transmit beams from the beam source to the target object, based on overlapping area coverage requirements of different time slots.

33.-37. (canceled)

38. A non-transitory computer readable storage medium storing instructions which, when executed by a processor, cause the processor to implement:
receiving a beam emitted from a beam source in the non-terrestrial wireless communication network, wherein the beam relay/reflection device is set based on the setting information of the beam source to receive the beam from the beam source, and
transmitting the received beam to a target object based on setting information of the target object,
wherein, the beam source is an aerial device capable of emitting beams in the non-terrestrial wireless communication network.

39. The non-transitory computer readable storage medium according to claim 19, wherein the instructions which, when executed by a processor, cause the processor to implement:
informing a control-side device in the non-terrestrial wireless communication network of the setting information of the beam relay device,
wherein the beam source sets beam emission based on the setting information of the beam relay device to perform the beam emission to the beam relay device, wherein the setting information of the beam relay device comprises orientation information of the beam relay device, wherein the orientation information comprises at least one of an altitude, an orientation, and a geographic location of the beam relay device, or
wherein the setting information of the beam relay device comprises at least one of identification information and operation parameter information of the beam relay device, wherein the operation parameter information comprises an operation time, an operation parameter of the beam relay device.

40. (canceled)
